(19) United States
(12) Patent Application Publication
(10) Pub. No.: US 2026/0012908 A1
(43) Pub. Date: Jan. 8, 2026

(54) UPLINK SYNCHRONIZATION METHOD AND APPARATUS, AND DEVICE, CHIP AND STORAGE MEDIUM

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN)

(73) Assignee: GUANGDONG OPPO MOBILE TELECOMMUNICATIONS CORP., LTD., Doungguan (CN)

(21) Appl. No.: 19/336,241

(22) Filed: Sep. 22, 2025

Related U.S. Application Data
(63) Continuation of application No. PCT/CN2023/086872, filed on Apr. 7, 2023.

(51) Int. Cl. H04W 56/00; H04W 52/36; H04W 74/0833

(52) U.S. Cl. CPC H04W 56/0015; H04W 52/36; H04W 74/0833

(57) ABSTRACT

Provided in the embodiments of the application is an uplink synchronization method, the method includes that: when a first condition is met, it is determined that a first random access process is completed, wherein the first random access process is used for establishing uplink synchronization between a terminal device and a first candidate cell, and the first condition is related to indicating that an underlying layer of the terminal device uses a first information transmission preamble.

### CROSS-REFERENCE TO RELATED APPLICATION

This is a continuation application of International Patent Application No. PCT/CN2023/086872, filed on Apr. 7, 2023, entitled “UPLINK SYNCHRONIZATION METHOD AND APPARATUS, AND DEVICE, CHIP AND STORAGE MEDIUM”, the disclosure of which is hereby incorporated by reference in its entirety.

### RELATED ART

In a random access process triggered based on a Physical Downlink Control Channel (PDCCH) order, a terminal device sends a preamble by using a random access resource explicitly indicated by a network, and starts a timer to monitor a Random Access Response (RAR) scheduled by the network side through a Random Access Radio Network Temporary Identifier (RA-RNTI). If the terminal device receives, during a RAR window, a RAR matched with an index of the sent preamble, it is considered that the random access process is completed successfully. Otherwise, the terminal device attempts to send the preamble again after the timer times out, while ramps transmission power of the preamble based on a number of attempts.

At present, for a random access process where there is no need to receive the RAR, there is no solution disclosing how the terminal device determines whether the random access process is completed.

### SUMMARY

Embodiments of the disclosure relate to the technical field of communications, and in particular to a method and apparatus for uplink (UL) synchronization, a device, a chip, and a storage medium. Embodiments of the disclosure provide a method and apparatus for UL synchronization, a device, a chip, and a storage medium.

According to a first aspect, an embodiment of the disclosure provides a method for UL synchronization, the method is applied to a terminal device, and the method includes the following operations. In case that a first condition is met, it is determined that a first random access process is completed, the first random access process is used to establish UL synchronization between the terminal device and a first candidate cell, and the first condition is related to indicating that an underlying layer of the terminal device transmits a preamble by using a first information.

According to a second aspect, an embodiment of the disclosure provides a terminal device for UL synchronization. The terminal device includes: a memory, configured to store computer executable instructions; and a processor, connected to the memory, and configured to execute the computer executable instructions to cause the terminal device to: in case that a first condition is met, determine that a first random access process is completed, the first random access process is used to establish UL synchronization between the apparatus and a first candidate cell, and the first condition is related to indicating that an underlying layer of the apparatus transmits a preamble by using a first information.

According to a third aspect, an embodiment of the disclosure provides a network device for UL synchronization. The network device includes: a memory, configured to store computer executable instructions; and a processor, connected to the memory, and configured to execute the computer executable instructions to cause the network device to: send a first indication information to a terminal device, the first indication information is used to trigger a random access process, the first indication information is used by the terminal device to determine a first information, a first condition is related to indicating that an underlying layer of the terminal device transmits a preamble by using the first information, the first condition is used to determine that a first random access process is completed, and the first random access process is used to establish UL synchronization between the terminal device and a first candidate cell.

### BRIEF DESCRIPTION OF THE DRAWINGS

The drawings described here are intended to provide further understanding of the disclosure, and constitute a part of the disclosure. Exemplary embodiments of the disclosure and descriptions thereof are intended to explain the disclosure, and do not constitute undue limitation on the disclosure. In the drawings:

FIG. 1 is a schematic diagram of an application scenario according to an embodiment of the disclosure;

FIG. 2 is a schematic flowchart of cell handover across base stations;

FIG. 3 is a schematic diagram of a basic flow of L1/L2-Triggered Mobility (LTM);

FIG. 4 is a first schematic flowchart of a method for UL synchronization provided in an embodiment of the disclosure;

FIG. 5 is a second schematic flowchart of a method for UL synchronization provided in an embodiment of the disclosure;

FIG. 6 is a schematic flowchart of another method for UL synchronization provided in an embodiment of the disclosure;

FIG. 7 is a first schematic diagram of a possible implementation flow of a method for UL synchronization provided in an embodiment of the disclosure;

FIG. 8 is a second schematic diagram of a possible implementation flow of a method for UL synchronization provided in an embodiment of the disclosure;

FIG. 9 is a third schematic diagram of a possible implementation flow of a method for UL synchronization provided in an embodiment of the disclosure;

FIG. 10 is a schematic diagram of a method for determining a retransmission interval of a preamble provided in an embodiment of the disclosure;

FIG. 11 is a first schematic structural diagram of an apparatus for UL synchronization provided in an embodiment of the disclosure;

FIG. 12 is a second schematic structural diagram of an apparatus for UL synchronization provided in an embodiment of the disclosure;

FIG. 13 is a schematic structural diagram of a communication device provided in an embodiment of the disclosure;

FIG. 14 is a schematic structural diagram of a chip according to an embodiment of the disclosure; and

FIG. 15 is a schematic block diagram of a communication system provided in an embodiment of the disclosure.

### DETAILED DESCRIPTION

Technical solutions in the embodiments of the disclosure will be described below with reference to the drawings in the embodiments of the disclosure. It is apparent that the described embodiments are part of the embodiments of the disclosure, rather than all of the embodiments. Based on the embodiments in the disclosure, all other embodiments obtained by those of ordinary skill in the art without paying any creative work belong to the scope of protection of the disclosure.

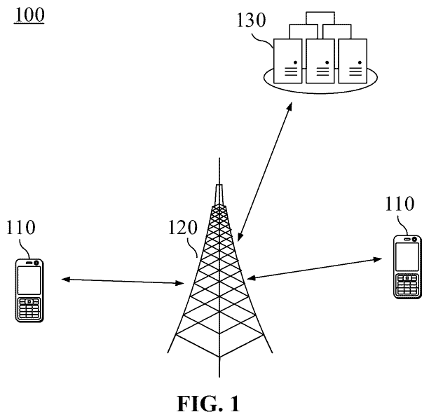

FIG. 1 is a schematic diagram of an application scenario according to an embodiment of the disclosure.

As illustrated in FIG. 1, a communication system 100 may include terminal devices 110 and a network device 120. The network device 120 may communicate with the terminal devices 110 through air interfaces. The terminal devices 110 and the network device 120 support multi-service transmission there-between.

It should be understood that the embodiments of the disclosure are only exemplified by the communication system 100, however, the embodiments of the disclosure are not limited thereto. That is, the technical solutions in the embodiments of the disclosure may be applied to various communication systems, such as a Long Term Evolution (LTE) system, an LTE Time Division Duplex (TDD) system, a Universal Mobile Telecommunication System (UMTS), an Internet of Things (IOT) system, a Narrow Band Internet of Things (NB-IOT) system, an enhanced Machine-Type Communications (eMTC) system, a 5G communication system (also referred to as a New Radio (NR) communication system), or a future communication system, etc.

In the communication system 100 illustrated in FIG. 1, the network device 120 may be an access network device that communicates with the terminal devices 110. The access network device may provide communication coverage for a specific geographical area, and may communicate with the terminal devices 110 (such as User Equipment (UE)) located in the coverage area.

The network device 120 may be an Evolutional Node B (eNB or eNodeB) in an LTE system, or a Next Generation Radio Access Network (NG RAN) device, or a base station (a next generation NodeB (gNB)) in an NR system, or a wireless controller in a Cloud Radio Access Network (CRAN); or the network device 120 may be a relay station, an access point, a vehicle device, a wearable device, a hub, a switch, a network bridge, a router, or a network device in a future evolved Public Land Mobile Network (PLMN), etc.

The terminal device 110 may be any terminal device, which includes but is not limited to a terminal device connected to the network device 120 or other terminal devices through a wired or wireless connection.

For example, the terminal device 110 may refer to an access terminal, UE, a user subscriber, a user station, a mobile station, a mobile radio station, a remote station, a remote terminal, a mobile device, a user terminal, a terminal, a wireless communication device, a user agent or a user device. The access terminal may be a cellphone, a cordless phone, a Session Initiation Protocol (SIP) phone, an IoT device, a satellite handheld terminal, a Wireless Local Loop (WLL) station, a Personal Digital Assistant (PDA), a handheld device with a wireless communication function, a computing device, another processing device connected to a wireless modem, a vehicle device, a wearable device, a terminal in a 5G network, or a terminal device in a future evolved network, etc.

The terminal device 110 may be used for Device to Device (D2D) communication.

The wireless communication system 100 may further include a core network device 130 that communicates with the network device 120, the core network device 130 may be a 5G Core (5GC) device, for example, an Access and Mobility Management Function (AMF), and for another example, an Authentication Server Function (AUSF), and for another example, a User Plane Function (UPF), and for another example, a Session Management Function (SMF). Optionally, the core network device 130 may also be an Evolved Packet Core (EPC) device of an LTE network, such as a Session Management Function+Core Packet Gateway (SMF+PGW-C) device. It should be understood that SMF+PGW-C may simultaneously implement functions that SMF and PGW-C may implement. In a process of network evolution, the above core network device may also be referred by other names, or a new network entity may be formed by dividing functions of the core network, which is not limited in the embodiments of the disclosure.

Various functional units in the communication system 100 may also establish connections there-between through a next generation (NG) network interface, to achieve communication.

For example, the terminal device establishes an air interface connection with the access network device through an NR interface, to transmit user plane data and control plane signaling; the terminal device may establish a control plane signaling connection with the AMF through an NG interface 1 (abbreviated as N1); the access network device, such as an NG wireless access base station (gNB), may establish a user plane data connection with the UPF through an NG interface 3 (abbreviated as N3); the access network device may establish a control plane signaling connection with the AMF through an NG interface 2 (abbreviated as N2); the UPF may establish a control plane signaling connection with the SMF through an NG interface 4 (abbreviated as N4); the UPF may exchange user plane data with a data network through an NG interface 6 (abbreviated as N6); the AMF may establish a control plane signaling connection with the SMF through an NG interface 11 (abbreviated as N11); the SMF may establish a control plane signaling connection with a Packet Control Function (PCF) through an NG interface 7 (abbreviated as N7).

One network device, one core network device and two terminal devices are exemplarily illustrated in FIG. 1. Optionally, the wireless communication system 100 may include multiple network devices, and another number of terminal devices may be included in the coverage of each network device, which is not limited in the embodiments of the disclosure.

It should be noted that FIG. 1 only illustrates the system to which the disclosure is applicable by way of example. Of course, methods illustrated in the embodiments of the disclosure may also be applicable to other systems. Furthermore, terms “system” and “network” in the disclosure may usually be used interchangeably. In the disclosure, term “and/or” is only an association relationship describing associated objects, and represents that three relationships may exist. For example, A and/or B may represent three conditions: i.e., existence of A alone, existence of both A and B, and existence of B alone. Furthermore, character “/” in the disclosure usually represents that anterior and posterior associated objects form an “or” relationship. It should also be understood that “indicate” mentioned in the embodiments of the disclosure may be a direct indication or an indirect indication, or may represent existence of an association relationship. For example, A indicates B, which may represent that A directly indicates B, for example, B may be obtained through A; or may represent that A indirectly indicates B, for example, A indicates C, B may be obtained through C; or may represent that there is an association relationship between A and B. It should also be understood that “correspond” mentioned in the embodiments of the disclosure may represent that there is a direct or indirect correspondence between two objects, or may represent that there is an association relationship between two objects, or may represent an indicating and indicated relationship, a configuring and configured relationship, etc. It should also be understood that “predefined” or “predefined rule” mentioned in the embodiments of the disclosure may be implemented by pre-saving corresponding codes, tables or other manners that may indicate relevant information, in a device (for example, including the terminal device and the network device), and specific implementation thereof is not limited in the disclosure. For example, “predefined” may refer to “defined” in a protocol. It should also be understood that in the embodiments of the disclosure, the “protocol” may refer to a standard protocol in the field of communications, for example, may include an LTE protocol, an NR protocol, and relevant protocols applied to future communication systems, which is not limited in the disclosure.

In a traditional random access process (usually, it is Non Contention or Contention Free Random Access (CFRA)) triggered based on a Physical Downlink Control Channel (PDCCH) order, UE sends a preamble by using a random access resource explicitly indicated by a network, and starts a timer (ra-ResponseWindow) to monitor a Random Access Response (RAR) scheduled by the network side through a Random Access Radio Network Temporary Identifier (RA-RNTI). If the UE receives, during a RAR window, a RAR matched with an index of the sent preamble, it is considered that the random access process is completed successfully. Otherwise, the UE attempts to send the preamble again after the timer times out, while ramps transmission power of the preamble based on a number of attempts.

At present, for a random access process where there is no need to receive the RAR, there is no solution disclosing how the UE determines whether the random access process is completed.

In view of this, the disclosure provides a method for uplink (UL) synchronization, in which in case that a first condition is met, the terminal device may determine that a first random access process is completed, the first random access process is used to establish UL synchronization between the terminal device and a first candidate cell. The first condition is related to indicating that an underlying layer of the terminal device transmits a preamble by using a first information. In this way, the terminal device may determine whether the random access process (such as the first random access process) is completed, based on whether the first condition is met. The solutions of the embodiments of the disclosure may be applied to a random access process where the terminal device needs to receive the RAR, or may be applied to a random access process where the terminal device does not need to receive the RAR.

In order to facilitate understanding the technical solutions in the embodiments of the disclosure, relevant technologies of the embodiments of the disclosure will be described below. The following relevant technologies may be arbitrarily combined with the technical solutions in the embodiments of the disclosure as optional solutions, and all of them belong to the scope of protection of the embodiments of the disclosure.

### 1. Cell Handover Process

Similar to the LTE system, the NR system supports a cell handover process for UE in a connected state. When a user who is using network services moves from one cell to another cell, or due to load adjustment of wireless transmission services, maintenance of an activation operation, failure of devices or the like, in order to ensure continuity of communications and quality of services, the system needs to transfer a communication link between the user and an original cell to a new cell, that is, perform the cell handover process.

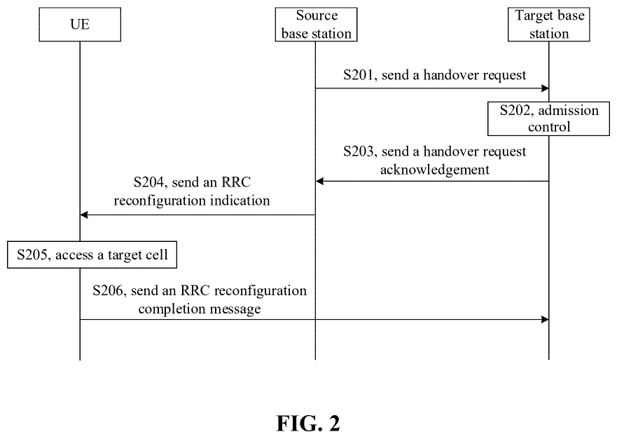

FIG. 2 is a schematic flowchart of cell handover across base stations, and the flow may include the following operations S201 to S206.

In operation S201, a source base station sends a handover request (HANDOVER REQUEST) to a target base station.

The source base station may trigger handover based on a layer 3 (L3) measurement result reported by a terminal, and send the handover request to a base station of a target cell (the target base station) through an Xn interface.

In operation S202, the target base station performs admission control.

After receiving the handover request from the source base station, the target base station may accept the handover request from the source base station.

In operation S203, the target base station sends a handover request acknowledgement (HANDOVER REQUEST ACKNOWLEDGE) to the source base station.

The target base station may provide a Radio Resource Control (RRC) configuration of the target cell, and feed back the RRC configuration of the target cell to the source base station as a part of the handover request acknowledgment.

In operation S204, the source base station sends an RRC reconfiguration indication (RRCReconfiguration) to the UE.

The source base station may send the RRC reconfiguration indication to the UE, to indicate the UE to initiate a handover process, and may send, to the UE, an RRC configuration for accessing the target cell.

In operation S205, the UE accesses a target cell.

In this operation, the UE may access the target cell based on the RRC reconfiguration indication and the RRC configuration of the target cell.

In operation S206, the UE sends an RRC reconfiguration completion message (RRCReconfigurationComplete) to the target base station.

After accessing the target cell, the UE may send the RRC reconfiguration completion message to the target base station. Further, in order to establish UL synchronization between the UE and the target cell, the UE needs to initiate a random access process to the target cell.

### 2. Basic Flow of L1/L2-Triggered Mobility (LTM)

A current cell handover process may be triggered by L3 signaling (RRCReconfiguration). In order to further reduce delay of a L3 handover process, an NR R18 mobility project will support a cell handover triggered based on layer 1/layer 2 (L1/L2) signaling, that is, the LTM.

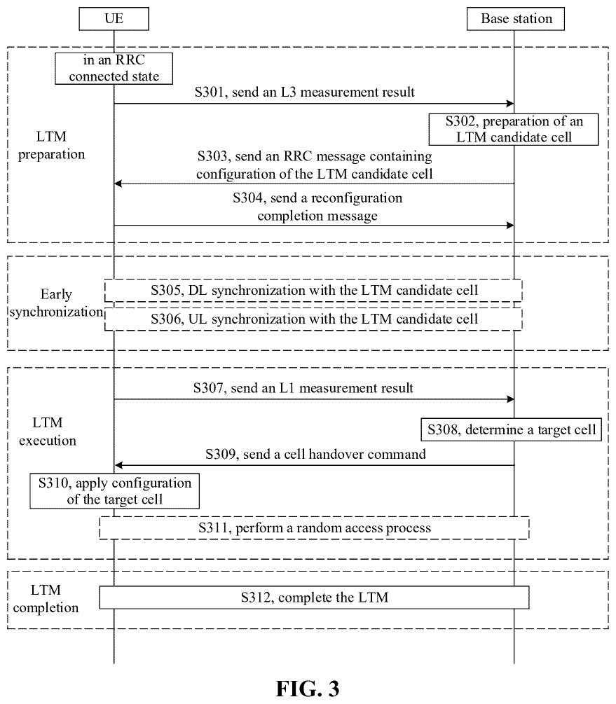

FIG. 3 illustrates a basic flow of the LTM. Before the flow starts, the UE may be in an RRC connected state (RRC_CONNECTED).

As illustrated in FIG. 3, the implementation flow may include four stages, which are an LTM preparation stage, an early synchronization stage, an LTM execution stage, and an LTM completion stage respectively. Implementation flows of the four stages will be introduced below respectively.

### Stage 1: LTM Preparation Stage, Which May Include the Following Operations S301 to S304

In operation S301, the UE sends (reports) an L3measurement result to the base station.

In operation S302, preparation of an LTM candidate cell is performed.

Based on the L3 measurement result, the base station determines to initiate an LTM process and triggers preparation of the LTM candidate cell. The LTM candidate cell may also be understood as a candidate cell for the LTM.

In operation S303, the base station sends an RRC message containing configuration of the LTM candidate cell to the UE.

The base station may send the RRC message (that is, an RRCReconfiguration message) containing configuration of the LTM candidate cell to the UE, there may be one or more candidate cells.

In operation S304, the UE sends a reconfiguration completion message to the base station.

After receiving configuration of the LTM candidate cell, the UE may store configuration of the LTM candidate cell and feed back the reconfiguration completion message (that is, an RRCReconfigurationComplete message) to the base station.

### Stage 2: Early Synchronization Stage, Which May Include the Following Operations S305 and S306.

In operation S305, the UE performs downlink (DL) synchronization with the LTM candidate cell.

In operation S306, the UE performs UL synchronization with the LTM candidate cell.

Before receiving an LTM cell handover command, the UE may perform UL/DL synchronization with the LTM candidate cell in advance, to reduce an interruption delay during handover.

### Stage 3: LTM Execution Stage, Which May Include the Following Operations S307 to S311.

In operation S307, the UE sends an L1 measurement result to the base station.

The UE performs L1 measurement on each candidate cell, and reports the L1 measurement result to the base station.

In operation S308, the base station determines a target cell.

The base station may determine the target cell based on the L1 measurement result reported by the UE.

In operation S309, the base station sends a cell handover command to the UE.

After determining the target cell, the base station may indicate the UE to hand over to the target cell through a Media Access Control Control Element (MAC CE).

In operation S310, the UE applies configuration of the target cell.

In operation S311, the UE performs a random access process with the base station.

If the UE does not have a valid Timing Advance (TA) for the target cell at present, the UE may initiate the random access process to the target cell after receiving the cell handover command.

### Stage 4: LTM Completion Stage, Which May Include the Following Operation S312

In operation S312, the LTM is completed.

After the UE and the base station complete the LTM, the UE may send, to the target cell, an indication information indicating that the LTM is completed successfully.

Relevant technologies/terms involved in the disclosure are briefly described as above, which will not be elaborated in the following embodiments.

In order to facilitate understanding the technical solutions of the embodiments of the disclosure, the technical solutions of the disclosure will be described in detail below through specific embodiments. The above relevant technologies may be arbitrarily combined with the technical solutions of the embodiments of the disclosure as optional solutions, and all of them belong to the scope of protection of the embodiments of the disclosure. The embodiments of the disclosure include at least a part of the following contents.

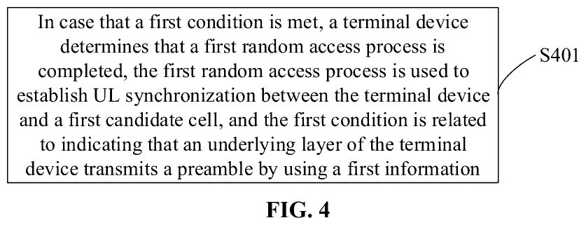

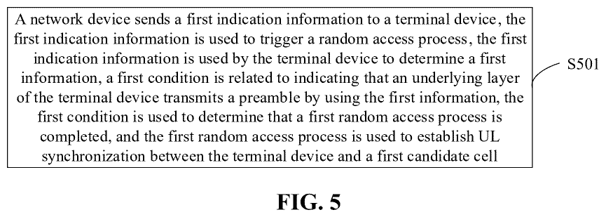

FIG. 4 and FIG. 5 illustrate a method for UL synchronization provided in an embodiment of the disclosure, the method may include the following operations S401 and S501.

In operation S401, in case that a first condition is met, a terminal device determines that a first random access process is completed, the first random access process is used to establish UL synchronization between the terminal device and a first candidate cell, and the first condition is related to indicating that an underlying layer of the terminal device transmits a preamble by using a first information.

The first random access process is a random access process initiated by the terminal device to the first candidate cell, and the first random access process may be used to establish UL synchronization between the terminal device and the first candidate cell. Exemplarily, the underlying layer of the terminal device may be for example a physical layer.

In operation S501, a network device sends a first indication information to a terminal device, the first indication information is used to trigger a random access process, the first indication information is used by the terminal device to determine a first information, a first condition is related to indicating that an underlying layer of the terminal device transmits a preamble by using the first information, the first condition is used to determine that a first random access process is completed, and the first random access process is used to establish UL synchronization between the terminal device and a first candidate cell.

Exemplarily, the network device may send the first indication information to the terminal device before the terminal device initiates the first random access process, and the first indication information may be used to trigger a random access process Correspondingly, the terminal device may receive the first indication information from the network device before initiating the first random access process. After receiving the first indication information, the terminal device may trigger, based on the first indication information, initiation of the first random access process to the first candidate cell, and may determine, based on the first indication information, the first information required to transmit the preamble in the first random access process.

In some embodiments, the first indication information may include an index of a candidate cell, and the index of the candidate cell may be used to indicate the terminal device to initiate a random access process to the candidate cell corresponding to the index of the candidate cell. For example, when the index of the candidate cell is an index of the first candidate cell, the terminal device may determine the first candidate cell based on the index of the candidate cell, and then initiate the random access process (that is, the first random access process) to the first candidate cell. That is, the first candidate cell is determined by the terminal device based on the index of the candidate cell contained in the first indication information.

According to the method of this embodiment, in case that the first condition is met, the terminal device may determine that the first random access process is completed, and the first condition is related to indicating the underlying layer of the terminal device to transmit the preamble by using the first information. Possible implementations of the first condition will be described below respectively.

In a first implementation (hereinafter, referred to as an implementation #1), the first condition may include: indicating that the underlying layer of the terminal device transmits the preamble by using the first information, or the first information is indicated (delivered) to the underlying layer of the terminal device.

That is, in the first random access process, if it is indicated that the underlying layer of the terminal device transmits the preamble by using the first information, it may be determined that the first random access process is completed. Alternatively, after the first information is indicated (delivered) to the underlying layer of the terminal device, it may be determined that the first random access process is completed. As an example, the first information may be for example indicated by a Media Access Control (MAC) layer of the terminal device.

In a second implementation (hereinafter, referred to as an implementation #2), the first condition includes that: a first timer times out.

The first timer may be started after it is indicated that the underlying layer of the terminal device transmits the preamble by using the first information. For example, a time when the first timer is started may be a time when the first information is indicated to the underlying layer of the terminal device; for another example, the time when the first timer is started may also be a first occasion of receiving the PDCCH after the preamble (a random access preamble) is transmitted.

It should be noted that there may be a time difference n between a time when the MAC layer indicates the first information to the underlying layer and a time when the preamble is transmitted. For example, the MAC layer may indicate the first information to the underlying layer at a time t, while a time when the underlying layer transmits the preamble may be a time t+n.

As an example, an operation duration (timing duration) of the first timer may be for example configured by the network device. The operation duration may be a pre-configured fixed value, or may be a dynamically configured value, which is not limited in the embodiments of the disclosure.

In some embodiments, if the terminal device receives the first indication information from the network device during operation of the first timer, the first timer may stop timing, or the first timer may be stopped in case that the terminal device receives the first indication information.

In some embodiments, the method may further include the following operation. In case that the first indication information is received during operation of the first timer, the terminal device determines, based on the first indication information, whether the first random access process is continuously performed.

Exemplarily, if the first indication information meets a second condition, the terminal device may continuously perform the first random access process; or if the first indication information does not meet the second condition, the terminal device may initiate a second random access process based on the first indication information.

That is, if the terminal device receives the first indication information again during operation of the first timer, the terminal device may determine, based on the first indication information received this time, whether the current first random access process is continuously performed. In an example, if the first indication information received this time meets the second condition, the terminal device may continuously perform the current random access process (that is, the first random access process); in another example, if the first indication information received this time does not meet the second condition, the terminal device may terminate the current first random access process, and initiate a new random access process (that is, the second random access process) based on the first indication information received this time.

It should be understood that in the embodiment of the disclosure, in case that the terminal device terminates the current first random access process, it may also be considered that the first random access process is completed. That is, “the random access process is completed” in the embodiment of the disclosure may refer to that the random access process is completed successful, or that the random access process is not completed successfully.

As an implementation, in case that the first indication information received this time does not meet the second condition, the terminal device may re-determine a random access resource based on the first indication information, and initiate the second random access process based on the re-determined random access resource. The second random access process may be for example a random access process initiated by the terminal device to a second candidate cell, and in this case, an index of the second candidate cell may be contained in the first indication information.

As an example, the second condition may include for example that: an index of a candidate cell contained in the first indication information is the same as an index of the first candidate cell; and/or a random access resource indicated by the first indication information is the same as a random access resource of the first random access process.

In a possible situation, the second condition may include that: the index of the candidate cell contained in the first indication information is the same as the index of the first candidate cell. The index of the first candidate cell may be for example contained in the first indication information previously received by the terminal device, and the first indication information previously received by the terminal device may be used to trigger the current first random access process. That is, if the index of the candidate cell contained in the first indication information previously received by the terminal device is the same as the index of the candidate cell contained in the first indication information received this time (that is, the first indication information received during operation of the first timer), it may be considered that the second condition is met.

In another possible situation, the second condition may include that: the index of the candidate cell contained in the first indication information is the same as the index of the first candidate cell, and the random access resource indicated by the first indication information is the same as the random access resource of the first random access process. That is, if the index of the candidate cell contained in the first indication information previously received by the terminal device is the same as the index of the candidate cell contained in the first indication information received this time (that is, the first indication information received during operation of the first timer) and the random access resource indicated by the first indication information previously received by the terminal device is the same as the random access resource indicated by the first indication information received this time (that is, the first indication information received during operation of the first timer), it may be considered that the second condition is met.

In yet another possible situation, the second condition may include that: the random access resource indicated by the first indication information is the same as the random access resource of the first random access process. That is, if the random access resource indicated by the first indication information previously received by the terminal device is the same as the random access resource indicated by the first indication information received this time (that is, the first indication information received during operation of the first timer), it may be considered that the second condition is met.

In a third implementation (hereinafter, referred to as an implementation #3), the first condition includes that: a number of transmissions of the preamble reaches a first number, or a second information is received by the terminal device before the number of transmissions of the preamble reaches the first number, the second information is a response to transmission of the preamble by the terminal device.

The preamble may be transmitted after it is indicated that the underlying layer of the terminal device transmits the preamble by using the first information. That is, the terminal device may transmit the preamble at least once after the first information is indicated to the underlying layer of the terminal device, or the terminal device may transmit the preamble at least once after it is indicated that the underlying layer of the terminal device transmits the preamble by using the first information.

In a possible situation, the first condition is that: the number of transmissions of the preamble reaches the first number. That is, if the number of transmissions of the preamble reaches the first number after indicating the first information to the underlying layer of the terminal device, it may be determined that the first random access process is completed.

As an example, the first number may be for example a maximum number of transmissions configured by the network device, or may be equal to the maximum number of transmissions configured by the network device+1. For example, if the maximum number of transmissions configured by the network device is 5, the first number may be 5 or 6. When the first number is 5, if a number of transmitting the preamble by the terminal device is equal to 5, it may be determined that the first random access process is completed; similarly, when the first number is 6, if the number of transmitting the preamble by the terminal device is equal to 6, it may be determined that the first random access process is completed.

In another possible situation, the first condition is that: the second information is received before the number of transmissions of the preamble reaches the first number. That is, if the terminal device receives a response (acknowledgment information) of the network device to transmission of the preamble by the terminal device before the number of transmissions of the preamble reaches the first number, it may be determined that the first random access process is completed.

In some embodiments, the method may further include the following operation. The terminal device performs repeated transmission of the preamble.

Exemplarily, the terminal device may perform repeated transmission of the preamble based on the maximum number of transmissions configured by the network device, after indicating the first information to the underlying layer of the terminal device. A transmission interval of the repeated transmission may be for example: a timing duration of a second timer; or an occurrence period of a random access resource. As an example, the timing duration of the second timer may be for example configured by the network device. The timing duration of the second timer may be a pre-configured fixed value, or may be a dynamically configured value, which is not limited in the embodiments of the disclosure.

In some embodiments, the method may further include the following operation. In case that the second information is received by the terminal device before the number of transmissions of the preamble reaches the first number, transmission of the preamble is stopped. That is, if the terminal device receives a response to transmission of the preamble by the terminal device before the number of transmissions of the preamble reaches the first number, transmission of the preamble may be stopped.

In some embodiments, the operation of in case that the first condition is met, determining that the first random access process is completed includes the following operation. In case that there is no need to receive a RAR and the first condition is met, it is determined that the first random access process is completed. That is, for the above implementation #1, implementation #2 and implementation #3, before determining whether the first condition is met, it may be determined whether the terminal device needs to receive the RAR. Further, if the terminal device does not need to receive the RAR, whether the first random access process is completed may be determined based on whether the first condition is met. That is, if the terminal device does not need to receive the RAR, whether the first random access process is completed may be determined based on the above implementation #1, implementation #2 or implementation #3, or the first condition is used to determine whether the first random access process is completed, in case that the terminal device does not need to receive the RAR. In this way, for an application scenario where the terminal device does not need to receive the RAR, the terminal device may determine whether the random access process (such as the first random access process) is completed, based on whether the first condition is met.

In some embodiments, the method may further include the following operation. The network device sends third information to the terminal device, the third information indicates whether the terminal device needs to receive the RAR. That is, the terminal device may receive the third information from the network device before determining whether it needs to receive the RAR, such that the terminal device may determine whether it needs to receive the RAR, based on contents indicated by the third information.

In some embodiments, the method may further include the following operations in case that the third information indicates that the RAR needs to be received. After indicating that the underlying layer of the terminal device transmits the preamble by using the first information, the terminal device monitors the RAR, an absolute timing advance command MAC CE or a timing advance command MAC CE in a serving cell of the terminal device, and scheduling a PDCCH of the RAR, the absolute timing advance command MAC CE or the timing advance command MAC CE to be scrambled by a Cell Radio Network Temporary Identifier (C-RNTI) and/or a RA-RNTI. Alternatively, the terminal device monitors the RAR in the first candidate cell, and scheduling the PDCCH of the RAR to be scrambled by the RA-RNTI.

As an example, after indicating the underlying layer of the terminal device to transmit the preamble by using the first information, the terminal device may monitor the RAR scheduled by the serving cell through the PDCCH scrambled by the C-RNTI and/or the RA-RNTI; or the terminal device may monitor the absolute timing advance command MAC CE or the timing advance command MAC CE scheduled by the serving cell through the PDCCH scrambled by the C-RNTI. As another example, the terminal device may monitor the RAR scheduled by the first candidate cell through the PDCCH scrambled by the RA-RNTI.

As an implementation, the method may further include the following operation after the terminal device having monitored the RAR. A UL grant and/or a Temporary C-RNTI (TC-RNTI) carried in the RAR are ignored.

In some embodiments, the method may further include the following operation. In case that a first indication information is received by the terminal device in the first random access process, the first indication information is ignored. For example, if the terminal device receives the first indication information during operation of the first timer or during repeated transmission of the preamble, an implementation is that the terminal device may ignore the first indication information.

In some embodiments, the method may further include the following operation. In case that an event triggering random access to a serving cell of the terminal device is met by the terminal device in the first random access process, the terminal device may terminate the first random access process, and initiate a random access process (for example, referred to as a third random access process) to the serving cell of the terminal device. That is, if the event triggering random access to the serving cell of the terminal device is met in a process of the terminal device initiating random access to the first candidate cell, the terminal device may terminate the first random access process performed currently, and preferentially initiate a random access process to the serving cell.

In some embodiments, the method may further include the following operation. In case that a first indication information is received in the third random access process, the first indication information is ignored. That is, if the first indication information is received in a process of the terminal device initiating random access to the serving cell, the first indication information may be ignored, to preferentially ensure that the current random access process is completed.

In some embodiments, the first information may include: transmission power of the preamble, and/or random access resource information. Therefore, when the terminal device needs to transmit the preamble, the transmission power of the preamble may be used as power for transmitting the preamble, and the preamble may be transmitted on a random access resource corresponding to the random access resource information.

Exemplarily, the transmission power of the preamble may be for example determined by the following manner #1, manner #2 or manner #3. Manner #1 to manner #3 will be introduced below respectively.

Manner #1: the transmission power of the preamble is contained in fourth information, and the fourth information is related to the transmission power of the preamble.

For example, the fourth information may include for example a specific value of the transmission power of the preamble. For example, if a value of the transmission power of the preamble contained in the fourth information is −180 dB, the transmission power of the preamble in the first information is −180 dB. Then, the terminal device may use −180 dB as the transmission power of the preamble to transmit the preamble.

In a possible manner, in order to further reduce signaling overhead, the network device may also configure at least one transmission power range (or a range of the transmission power of the preamble) for the terminal device, and each transmission power range may correspond to an index. In this case, the fourth information may include an index of the transmission power range, without containing a specific value of the transmission power of the preamble. In this way, after obtaining the index of the transmission power range, the terminal device may determine the transmission power of the preamble from the transmission power range corresponding to the index. For example, the terminal device may randomly determine a transmission power of the preamble from the transmission power range corresponding to the index.

Table 1 is an example of transmission power ranges and corresponding indexes.

TABLE 1

| index | transmission power range (with a unit of dB) |
|---|---|
| 0 | −200~−180 |
| 1 | −180~−160 |
| . . . | . . . |
| N | −80~−60 |

Taking Table 1 as an example, the fourth information may include an index “1”, such that the terminal device may randomly determine a transmission power of the preamble such as −170 dB, from a transmission power range “−180 ˜−160” corresponding to the index “1”.

As an implementation, the fourth information may be for example contained in a first indication information, and the first indication information may be used to trigger a random access process. Exemplarily, the terminal device may receive the first indication information from the network device before initiating the first random access process to the first candidate cell, and then the terminal device may determine the transmission power of the preamble based on the fourth information contained in the first indication information.

Manner #2: the transmission power of the preamble is determined based on the fourth information and fifth information, and the fifth information is used to configure or initialize parameters and/or variables related to the first random access process.

As an example, the fifth information may include a preamble received target power (preambleReceivedTargetPower) and/or a second power ramping step.

Exemplarily, if the transmission power of the preamble is determined based on the fourth information and the fifth information, the fourth information may include at least one of: a first power ramping step; a power ramping counter; a power ramping offset; or a power ramping factor.

A product of the power ramping counter (Counter) and the power ramping step (powerRampingStep) (for example, the first power ramping step; for another example, the second power ramping step) may indicate a power ramping amount between two continuous transmissions of the preamble. The power ramping offset (ramping offset) may be for example represented by the product of the power ramping step and the power ramping counter, that is, the power ramping offset=the power ramping step×the power ramping counter. The power ramping factor may indicate a ratio of powers of two continuous transmissions of the preamble.

In an example, the fourth information includes the power ramping offset (ramping offset). In this case, the transmission power of the preamble (PREAMBLE_RECEIVED_TARGET_POWER) may be calculated by the following formula (1):

$$PREAMBLE\_RECEIVED \_TARGET \_POWER = preambleReceivedTargetPower + DELTA\_PREAMBLE + ramping offset ; \qquad ( 1 )$$

here DELTA_PREAMBLE is an adjustment amount defined by the protocol, and preambleReceivedTargetPower is the preamble received target power contained in the fifth information.

As an implementation, in order to further reduce signaling overhead, the network device may also configure at least one power ramping offset range for the terminal, and each power ramping offset range corresponds to an index. In this case, the fourth information may contain an index of the power ramping offset range, without containing a specific power ramping offset. In this way, after obtaining the index of the power ramping offset range, the terminal device may determine the power ramping offset from the power ramping offset range corresponding to the index. For example, the terminal device may randomly determine a power ramping offset from the power ramping offset range corresponding to the index.

In another example, the fourth information includes the power ramping factor (ramping factor). In this case, the transmission power of the preamble may be calculated by the following formula (2):

$$PREAMBLE\_RECEIVED \_TARGET \_POWER = ( preambleReceivedTargetPower + DELTA\_PREAMBLE ) \times ramping factor ; \qquad ( 2 )$$

here DELTA_PREAMBLE is an adjustment amount defined by the protocol, and preambleReceivedTargetPower is the preamble received target power contained in the fifth information.

In yet another example, the fourth information includes the power ramping step (powerRampingStep) and/or a first power ramping counter (Counter). In this case, the transmission power of the preamble may be calculated by the following formula (3):

$$PREAMBLE\_RECEIVED \_TARGET \_POWER = preambleReceivedTargetPower + DELTA\_PREAMBLE + Counter \times PREAMBLE\_POWER \_RAMPING \_STEP ; \qquad ( 3 )$$

here DELTA_PREAMBLE is an adjustment amount defined by the protocol, and preambleReceivedTargetPower is the preamble received target power contained in the fifth information. The variable PREAMBLE_POWER_RAMPING_STEP may be assigned with a value by using the first power ramping step in the fourth information, or may be assigned with a value by using the second power ramping step in the fifth information, which is not limited in the embodiments of the disclosure.

Manner #3: the transmission power of the preamble is determined based on the fifth information and a number of power ramping of the preamble.

The number of power ramping of the preamble (PREAMBLE_POWER_RAMPING_COUNTER) may represent a number of ramping the transmission power of the preamble in the random access process (such as the first random access process). For example, if the number of power ramping of the preamble is j (j is a positive integer), it means that the transmission power of the preamble is ramped j times. In this embodiment, an initial value of the number of power ramping of the preamble may be for example 1, and the number of power ramping of the preamble may be increased by 1 each time the transmission power of the preamble is ramped, or in case that it is determined to ramp the transmission power of the preamble.

As an implementation, the transmission power of the preamble may be calculated by the following formula (4):

$$PREAMBLE\_RECEIVED \_TARGET \_POWER = preambleReceivedTargetPower + DELTA\_PREAMBLE + ( PREAMBLE\_POWER \_RAMPING \_COUNTER - 1 ) \times PREAMBLE\_POWER \_RAMPING \_STEP ; \qquad ( 4 )$$

here DELTA_PREAMBLE is an adjustment amount defined by the protocol, and preambleReceivedTargetPower is the preamble received target power in the fifth information. The variable PREAMBLE_POWER_RAMPING_STEP may be assigned with a value by using the first power ramping step in the first indication information, or may be assigned with a value by using the second power ramping step in the fifth information, which is not limited in the embodiments of the disclosure.

In some embodiments, the fifth information may be for example obtained as follows.

In an example, the fifth information may be contained in a cell configuration corresponding to the first candidate cell. For example, the fifth information may be a Random Access Channel (RACH) configuration on a first active Band Width Part (First Active BWP) of the first candidate cell. The cell configuration corresponding to the first candidate cell may be for example contained in a cell configuration corresponding to at least one candidate cell from the network device.

In another example, the fifth information may be contained in a cell configuration corresponding to a serving cell of the terminal device.

In yet another example, the fifth information may be determined based on the first indication information. For example, the first indication information may contain a Band Width Part (BWP) identifier (ID), and the fifth information may be a RACH configuration on a BWP corresponding to the BWP ID. Therefore, after obtaining the first indication information, the terminal device may determine a corresponding BWP based on the BWP ID in the first indication information, and then determine the RACH configuration on the BWP as the fifth information.

In some embodiments, the fifth information further includes sixth information. In a process of configuring or initializing the parameters and/or variables related to the first random access process, the terminal device may preferentially configure or initialize, based on the sixth information, the parameters and/or variables related to the first random access process.

The sixth information may also be understood as a high priority configuration (ra-PrioritizationForLTM) for initiating random access to the first candidate cell. In this way, the terminal device may preferentially configure or initialize the parameters and/or variables related to the first random access process, based on parameters contained in the high priority configuration. As an example, the sixth information may include for example powerRampingStepHighPriority and scalingFactorBI. power RampingStepHighPriority may be used to configure or initialize the power ramping step used in the random access process, and scalingFactorBI is a scaling factor of a fallback indication.

In some embodiments, the fifth information may be used for at least one of the following random access processes.
1) A random access process triggered by layer 1 or layer 2 signaling. Alternatively, the fifth information may be dedicated to random access of the LTM.
2) A random access process triggered by layer 3 signaling. Alternatively, the fifth information may be used in random access based on cell handover triggered by layer 3.
3) A random access process triggered by layer 1 or layer 2 signaling before receiving a cell handover command from the network device. Alternatively, the fifth information may be used in random access initiated to the LTM candidate cell before receiving the cell handover command.

In some embodiments, a ramping rule of the transmission power of the preamble may include: ramping the transmission power of the preamble after the terminal device performs at least one transmission of the preamble by using a same transmission power of the preamble; and/or based on whether Synchronization Signal Blocks (SSBs) contained in continuously received first indication information are the same, the terminal device determining whether to ramp the transmission power of the preamble.

The continuously received first indication information may also be understood as the first indication information received at times one after another or at two adjacent times.

For example, assuming that the ramping rule of the transmission power of the preamble includes: ramping the transmission power of the preamble after performing at least one transmission of the preamble by using the same transmission power of the preamble. Then, the terminal device may ramp the transmission power of the preamble after performing transmission of the preamble once by using the same transmission power of the preamble, that is, the terminal device may ramp the transmission power of the preamble once each time it performs transmission of the preamble; or the terminal device may ramp the transmission power of the preamble after performing multiple (such as two or more) transmissions of the preamble by using the same transmission power of the preamble, that is, the terminal device may ramp the transmission power of the preamble once after performing multiple transmissions of the preamble.

In some embodiments, the method may further include the following operation. In case that it is determined to ramp the transmission power of the preamble, the terminal device increases the number of power ramping of the preamble by 1. Correspondingly, in case that there is no need to ramp the transmission power of the preamble, the terminal device may not need to update the number of power ramping of the preamble.

In some embodiments, the random access resource information in the first information may be determined based on seventh information. The seventh information may indicate a random access resource of the first random access process. As an implementation, the seventh information may be for example contained in the first indication information. In this way, after receiving the first indication information, the terminal device may determine the random access resource used in the first random access process, based on the seventh information contained in the first indication information.

As an example, the seventh information may include for example at least one of: a preamble index (Preamble Index); an SSB index (SSB Index); a Physical Random Access Channel (PRACH) mask index (PRACH Mask Index); a Normal Uplink (NUL) or Supplementary Uplink (SUL) indicator (NUL/SUL Indicator); or a BWP ID.

According to the method of this embodiment, in case that the first condition is met, the terminal device may determine that the first random access process is completed, and the first condition is related to indicating that the underlying layer of the terminal device transmits the preamble by using the first information. In this way, for a random access process where there is no need to receive the RAR, the terminal device may determine whether the first random access process is completed, based on whether the first condition is met.

Exemplarily, in some scenarios, the first random access process in the embodiment of the disclosure may be for example a random access process triggered by layer 1 or layer 2 signaling. That is, the first random access process may be a random access process in an LTM scenario. In this scenario, the first candidate cell may be a candidate cell for the LTM.

In some scenarios, before receiving the cell handover command from the network device, the terminal device may initiate a random access process to the first candidate cell in advance based on the indication of the network device, to establish UL synchronization between the terminal device and the first candidate cell in advance, thereby reducing an interruption delay during cell handover.

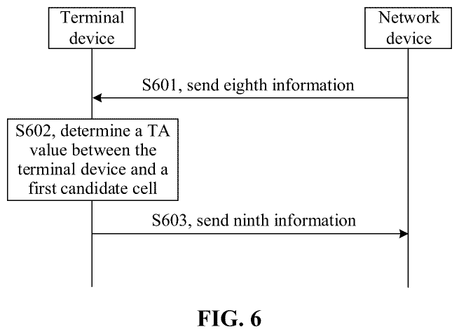

Another method for UL synchronization provided in an embodiment of the disclosure will be introduced below with reference to FIG. 6.

FIG. 6 illustrates another method for UL synchronization provided in an embodiment of the disclosure, the method may include the following operations S601 to S603.

In operation S601, a network device sends eighth information to a terminal device. Correspondingly, the terminal device may receive the eighth information from the network device.

The eighth information is used to determine a TA value between the terminal device and a first candidate cell, and the TA value may be used to establish UL synchronization between the terminal device and the first candidate cell. As an example, the eighth information may include for example a DL timing difference between the first candidate cell and a serving cell of the terminal device.

In a possible manner, the network device may send the eighth information to the terminal device before sending a cell handover command to the terminal device. Correspondingly, the terminal device may receive the eighth information from the network device before receiving the cell handover command from the network device.

In operation S602, the terminal device determines a TA value between the terminal device and a first candidate cell.

In this operation, the terminal device may determine the TA value between the terminal device and the first candidate cell based on the received eighth information, or the terminal device may determine the TA value between the terminal device and the first candidate cell based on the DL timing difference between the first candidate cell and the serving cell of the terminal device.

In operation S603, the terminal device sends ninth information to the network device. Correspondingly, the network device receives the ninth information from the terminal device.

After determining the TA value between the terminal device and the first candidate cell, the terminal device may report TA-related information to the network device. As an implementation, the TA-related information may be for example contained in the ninth information. As an example, the ninth information may include at least one of: an ID of the first candidate cell; the TA value between the terminal device and the first candidate cell; or an adjustment amount based on a TA value used by a serving cell of the terminal device.

In some embodiments, the method may further include the following operations before the terminal device sends the ninth information to the network device. The network device sends tenth information to the terminal device, and correspondingly, the terminal device may receive the tenth information from the network device. The tenth information is used to indicate that the terminal device determines the TA value between the terminal device and the first candidate cell, and/or sends the ninth information to the network device. That is, the network device may indicate whether the terminal device needs to determine the TA value between the terminal device and the first candidate cell, and/or whether the TA-related information (that is, the ninth information) needs to be reported to the network device, by sending the tenth information to the terminal device.

According to the method of this embodiment, the terminal device may determine the TA value between the terminal device and the first candidate cell before receiving the cell handover command from the network device, and report the TA-related information to the network device, thereby establishing UL synchronization between the terminal device and the first candidate cell in advance, to reduce the interruption delay during cell handover.

It should be noted that the method illustrated in FIG. 6 may be implemented individually, or may be implemented in combination with methods illustrated in FIG. 4 and FIG. 5, which is not limited in the embodiments of the disclosure.

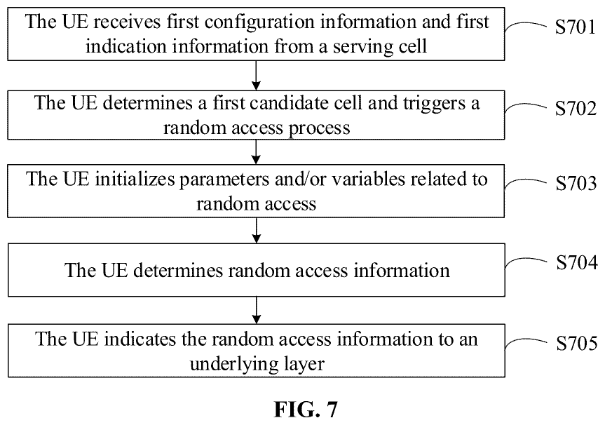

A method for UL synchronization provided in the embodiment of the disclosure has been introduced as above with reference to FIG. 4 to FIG. 6. In order to facilitate understanding the embodiments of the disclosure, possible implementation flows of the method for UL synchronization provided in the embodiment of the disclosure will be introduced below with reference to FIG. 7 to FIG. 9 by taking the LTM scenario as an example. It should be noted that in examples of FIG. 7 to FIG. 9, the network device may be for example a network device corresponding to a service cell of the UE. That is, communication between the UE and the network device may be understood as communication between the UE and the service cell.

FIG. 7 is a first schematic diagram of a possible implementation flow of a method for UL synchronization provided in an embodiment of the disclosure. The implementation flow may include the following operations S701 to S705.

In operation S701, the UE receives first configuration information and first indication information from a serving cell.

In some embodiments, the serving cell may send the first configuration information to the UE, and correspondingly, the UE may receive the first configuration information from the serving cell. The first configuration information may include a cell configuration corresponding to at least one candidate cell for the LTM (hereinafter, referred to as an LTM cell). It should be understood that the serving cell in the embodiment of the disclosure may be for example a Primary Cell (PCell), a Primary Secondary Cell (PSCell), or a Secondary Cell (SCell).

After receiving the first configuration information, the UE may perform L1 measurement on all or part of the at least one LTM candidate cell, and report a measurement result obtained by performing the L1 measurement to the serving cell.

In some embodiments, the serving cell may also send the first indication information to the UE, and correspondingly, the UE may receive the first indication information from the serving cell. Exemplarily, the first indication information may include, but is not limited to at least one of: an index (ID) of a candidate cell; an indication information of a random access resource; or parameter information related to the transmission power of the preamble. The above information will be introduced below respectively.
1) Index (ID) of the candidate cell. The index of the candidate cell may be used by the UE to determine a first candidate cell, and then initiate a random access process to the first candidate cell. Alternatively, the index of the candidate cell is an index of the first candidate cell. In a possible manner, the first candidate cell may be for example determined by the serving cell based on the LI measurement result reported by the UE.
2) Indication information of the random access resource (corresponding to the seventh information in the foregoing embodiment). The indication information of the random access resource may be used by the UE to determine the random access resource used in the random access process. As an example, the indication information of the random access resource may include at least one of: a Preamble Index; an SSB Index; a PRACH Mask Index; a NUL/SUL Indicator; or a BWP ID.
3) Parameter information related to the transmission power of the preamble (corresponding to the fourth information in the foregoing embodiment). The parameter information related to the transmission power of the preamble may be used by the UE to determine the transmission power of the preamble when the preamble is transmitted. As an example, the parameter information related to the transmission power of the preamble may include for example at least one of: the transmission power of the preamble; a power ramping step (hereinafter, referred to as a first power ramping step); a power ramping counter; a power ramping offset; or a power ramping factor.

A product of the power ramping counter and the power ramping step may indicate a power ramping amount of two continuous transmissions of the preamble. The power ramping offset may be for example represented by the product of the power ramping step and the power ramping counter, that is, the power ramping offset=the power ramping step×the power ramping counter. The power ramping factor may indicate a ratio of powers of two continuous transmissions of the preamble.

In operation S702, the UE determines a first candidate cell and triggers a random access process.

The UE may determine the first candidate cell according to the index of the candidate cell in the first indication information, and trigger initiation of a random access process to the first candidate cell. As an example, initiation of the random access process to the first candidate cell by the UE may include the following operations S703 to S705.

In operation S703, the UE initializes parameters and/or variables related to random access.

For example, the parameters related to random access (or, referred to as parameters related to the random access process) may include, but are not limited to: a preamble received target power (preambleReceivedTargetPower) and/or a power ramping step (powerRampingStep). The variables related to random access (or, referred to as variables related to the random access process) may also be understood as variables that the UE needs to maintain in the random access process. For example, the variables related to random access may include, but are not limited to at least one of: a cell maximum transmission power (PCMAX), a Preamble Index (PREAMBLE_INDEX), or a preamble transmission power (PREAMBLE_RECEIVED_TARGET_POWER). PREAMBLE_RECEIVED_TARGET_POWER is the transmission power of the preamble used by the UE when the preamble is transmitted.

In a possible manner, all or part of power-related parameters such as preambleReceivedTargetPower, powerRampingStep or the like may be for example determined by the first indication information; in another possible manner, all or part of the above power-related parameters may also be determined by a first RRC configuration (corresponding to the fifth information in the foregoing embodiment), and the first RRC configuration is a configuration required to initiate random access to the first candidate cell.

In an example, the first RRC configuration may be contained in a cell configuration corresponding to the first candidate cell. For example, the first RRC configuration is a RACH configuration on a First Active BWP of the first candidate cell. In another example, the first RRC configuration may also be contained in a cell configuration corresponding to the current serving cell of the UE. In yet another example, the first RRC configuration may also be determined based on the first indication information. For example, the first RRC configuration may be a RACH configuration on a BWP corresponding to a BWP ID in the first indication information, such that the UE may determine a corresponding BWP based on the BWP ID in the first indication information, and then determine the RACH configuration on the BWP as the first RRC configuration.

In operation S704, the UE determines random access information (corresponding to the first information in the foregoing embodiment).

The random access information may include: random access resource information and/or transmission power of the preamble.

Exemplarily, the UE may determine the random access resource information by selecting a random access resource. The random access resource selected by the UE may include: NUL/SUL, a BWP, a RACH Preamble Index, an SSB Index, and a PRACH Mask Index. The random access resource selected by the UE may be a random access resource indicated in the first indication information, or the random access resource selected by the UE is determined based on indication information of the random access resource in the first indication information.

Exemplarily, the UE may also determine the transmission power of the preamble.

In a first implementation, the first indication information may contain an absolute transmission power value (or a specific value of the transmission power of the preamble), that is, the transmission power of the preamble may be contained in the first indication information. That is, in case that the first indication information contains the specific value of the transmission power of the preamble, the specific value of the transmission power of the preamble may be determined as the transmission power of the preamble when the preamble is transmitted.

Optionally, in order to further reduce signaling overhead, the network device may also configure at least one transmission power range for the UE, and each transmission power range corresponds to an index. In this case, the first indication information may contain an index of the transmission power range, without containing an absolute transmission power value (or a specific value of the transmission power of the preamble). In this way, after obtaining the index of the transmission power range, the UE may determine the transmission power of the preamble from the transmission power range corresponding to the index. For example, the UE may randomly determine a transmission power of the preamble from the transmission power range corresponding to the index.

In a second implementation, the transmission power of the preamble is determined based on the first indication information and the first RRC configuration. At this time, the first indication information may include at least one of: a first power ramping step; a power ramping counter; a power ramping offset; or a power ramping factor.

In an example, the first indication information includes the power ramping offset (ramping offset). In this case, the transmission power of the preamble (PREAMBLE_RECEIVED_TARGET_POWER) may be calculated by the following formula (5):

$$PREAMBLE\_RECEIVED \_TARGET \_POWER = preambleReceivedTargetPower + DELTA\_PREAMBLE + ramping offset ; \qquad ( 5 )$$

here DELTA_PREAMBLE is an adjustment amount defined by the protocol, and preambleReceivedTargetPower is the preamble received target power in the first RRC configuration.

Optionally, in order to further reduce signaling overhead, the network device may also configure at least one power ramping offset range for the UE, and each power ramping offset range corresponds to an index. In this case, the first indication information may contain an index of the power ramping offset range, without containing a specific power ramping offset. In this way, after obtaining the index of the power ramping offset range, the UE may determine the power ramping offset from the power ramping offset range corresponding to the index. For example, the UE may randomly determine a power ramping offset from the power ramping offset range corresponding to the index

In another example, the first indication information includes the power ramping factor (ramping factor). In this case, the transmission power of the preamble may be calculated by the following formula (6):

$$PREAMBLE\_RECEIVED \_TARGET \_POWER = ( preambleReceivedTargetPower + DELTA\_PREAMBLE ) \times ramping factor ; \qquad ( 6 )$$

here DELTA_PREAMBLE is an adjustment amount defined by the protocol, and preambleReceivedTargetPower is the preamble received target power in the first RRC configuration.

In yet another example, the first indication information includes the power ramping step (powerRampingStep) and/or a first power ramping counter (Counter). In this case, the transmission power of the preamble may be calculated by the following formula (7):

$$PREAMBLE\_RECEIVED \_TARGET \_POWER = preambleReceivedTargetPower + DELTA\_PREAMBLE + Counter \times PREAMBLE\_POWER \_RAMPING \_STEP ; \qquad ( 7 )$$

here DELTA_PREAMBLE is an adjustment amount defined by the protocol, and preambleReceivedTargetPower is the preamble received target power in the first RRC configuration. The variable PREAMBLE_POWER_RAMPING_STEP may be assigned with a value by using the first power ramping step in the first indication information, or may be assigned with a value by using the second power ramping step in the first RRC configuration, which is not limited in the embodiments of the disclosure.

In operation 705, the UE indicates the random access information to an underlying layer.

In this operation, the UE may indicate (deliver) the random access information (the random access resource information and/or the transmission power of the preamble) determined in the operation S704 to the underlying layer. After the UE indicates the random access information to the underlying layer, it may be considered that the random access process is completed.

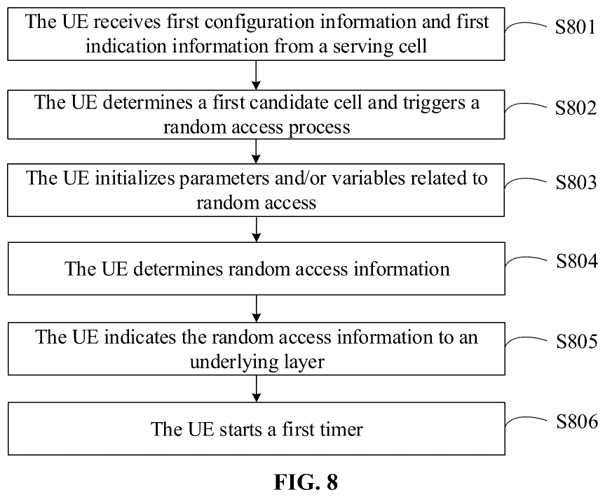

FIG. 8 is a second schematic diagram of a possible implementation flow of a method for UL synchronization provided in an embodiment of the disclosure. The implementation flow may include the following operations S801 to S806.

In operation S801, the UE receives first configuration information and first indication information from a serving cell.

In some embodiments, the serving cell may send the first configuration information to the UE, and correspondingly, the UE may receive the first configuration information from the serving cell. The first configuration information may include a cell configuration corresponding to at least one candidate cell for the LTM. It should be understood that the serving cell in the embodiment of the disclosure may be for example a PCell, a PSCell, or a SCell.

After receiving the first configuration information, the UE may perform L1 measurement on all or part of the at least one LTM candidate cell, and report a measurement result obtained by performing the L1 measurement to the serving cell.

In some embodiments, the serving cell may also send the first indication information to the UE, and correspondingly, the UE may receive the first indication information from the serving cell. Exemplarily, the first indication information may include, but is not limited to at least one of: an index (ID) of a candidate cell; an indication information of a random access resource; or parameter information related to the transmission power of the preamble. Introduction of the above information may refer to the operation S701 in the foregoing embodiment, which will not be elaborated here to avoid repetition.

In operation S802, the UE determines a first candidate cell and triggers a random access process.

The UE may determine the first candidate cell according to the index of the first candidate cell in the first indication information, and trigger initiation of a random access process to the first candidate cell. As an example, initiation of the random access process to the first candidate cell by the UE may include the following operations S803 to S806.

In operation S803, the UE initializes parameters and/or variables related to random access.

For example, the parameters related to random access may include, but are not limited to: a preamble received target power (preambleReceivedTargetPower) and/or a power ramping step (powerRampingStep). The variables related to random access may also be understood as variables that the UE needs to maintain in the random access process. For example, the variables related to random access may include, but are not limited to at least one of: a cell maximum transmission power (PCMAX), a Preamble Index (PREAMBLE_INDEX), a preamble received target power (PREAMBLE_RECEIVED_TARGET_POWER), or a number of power ramping of the preamble (PREAMBLE_POWER_RAMPING_COUNTER). The number of power ramping of the preamble may represent a number of ramping the transmission power of the preamble in the random access process. For example, if the number of power ramping of the preamble is j (j is a positive integer), it means that the transmission power of the preamble is ramped j times. In this embodiment, an initial value of the number of power ramping of the preamble may be for example 1, and the number of power ramping of the preamble may be increased by 1 each time the transmission power of the preamble is ramped, or in case that it is determined to ramp the transmission power of the preamble.

In a possible manner, all or part of power-related parameters such as preambleReceivedTargetPower, powerRampingStep or the like may be for example determined by the first indication information; in another possible manner, all or part of the above power-related parameters may also be determined by a first RRC configuration, and the first RRC configuration is a configuration required to initiate random access to the first candidate cell.

In an example, the first RRC configuration may be contained in a cell configuration corresponding to the first candidate cell. For example, the first RRC configuration is a RACH configuration on a First Active BWP of the first candidate cell. In another example, the first RRC configuration may also be contained in a cell configuration corresponding to the current serving cell of the UE. In yet another example, the first RRC configuration may also be determined based on the first indication information. For example, the first RRC configuration may be a RACH configuration on a BWP corresponding to a BWP ID in the first indication information, such that the UE may determine a corresponding BWP based on the BWP ID in the first indication information, and then determine the RACH configuration on the BWP as the first RRC configuration.

In operation S804, the UE determines random access information.

The random access information may include: random access resource information and/or transmission power of the preamble.

Exemplarily, the UE may determine the random access resource information by selecting a random access resource. The random access resource selected by the UE may include: NUL/SUL, a BWP, a RACH Preamble Index, an SSB Index, and a PRACH Mask Index. The random access resource selected by the UE may be a random access resource indicated in the first indication information, or the random access resource selected by the UE is determined based on indication information of the random access resource in the first indication information.

Exemplarily, the UE may also determine the transmission power of the preamble.

In a first implementation, the transmission power of the preamble may be determined based on the first RRC configuration and the number of power ramping of the preamble (PREAMBLE_POWER_RAMPING_COUNTER), and a calculation formula thereof is shown in formula (8):

$$PREAMBLE\_RECEIVED \_TARGET \_POWER = preambleReceivedTargetPower + DELTA\_PREAMBLE + ( PREAMBLE\_POWER \_RAMPING \_COUNTER - 1 ) \times PREAMBLE\_POWER \_RAMPING \_STEP ; \qquad ( 8 )$$

here DELTA_PREAMBLE is an adjustment amount defined by the protocol, and preambleReceivedTargetPower is the preamble received target power in the first RRC configuration. The variable PREAMBLE_POWER_RAMPING_STEP may be assigned with a value by using the first power ramping step in the first indication information, or may be assigned with a value by using the second power ramping step in the first RRC configuration, which is not limited in the embodiments of the disclosure.

In a second implementation, the UE may determine the transmission power of the preamble based on the first indication information. The method for determining the transmission power of the preamble by the UE based on the first indication information may refer to the operation S604 in the foregoing embodiment, which will not be elaborated here.

In operation S805, the UE indicates the random access information to an underlying layer.

In this operation, the UE may indicate (deliver) the random access information (the random access resource information and/or the transmission power of the preamble) determined in the operation S804 to the underlying layer.

After indicating the random access information to the underlying layer, behaviors of the UE may include the following operation S806.

In operation S806, the UE starts a first timer.

If the UE receives the first indication information again during operation of the first timer, PREAMBLE_POWER_RAMPING_COUNTER is increased by 1, and operations S804 and S805 are executed again. Otherwise, when the first timer times out, if the UE does not receive the first indication information again, it may be considered that the random access process is completed.

In a possible manner, when the UE receives the first indication information again during operation of the first timer, the UE may determine whether the index of the candidate cell, the SSB Index, the Preamble Index and the PRACH Mask Index indicated in the first indication information are the same as the first indication information received last time.

In a possible situation, if contents indicated in the first indication information received this time are completely the same as contents indicated in the first indication information received last time, the current random access process is continuously performed; otherwise, the current random access process is terminated, and a new random access process is triggered based on the first indication information received this time.

It should be understood that in the embodiment of the disclosure, after the current random access process is terminated, it may also be considered that the current random access process is completed.

Exemplarily, in case that the contents indicated in the first indication information received this time are completely the same as the contents indicated in the first indication information received last time, the UE may increase PREAMBLE_POWER_RAMPING_COUNTER by 1, and re-determine the random access information (the random access resource information and/or the transmission power of the preamble) based on the first indication information received this time and/or the first RRC configuration, and indicate the re-determined random access information to the underlying layer (that is, operations S804 and S805 are re-executed). It may be understood that if the contents indicated in the first indication information received this time are completely the same as the contents indicated in the first indication information received last time, the UE may not need to select the random access resource again, or the UE may select the same random access resource as that selected in the previous time.

In another possible situation, if the index of the candidate cell in the first indication information received this time is the same as the index of the candidate cell in the first indication information received last time, PREAMBLE_POWER_RAMPING_COUNTER may be increased by 1, and the current random access process may be continuously performed (that is, operations S804 and S805 are re-executed); otherwise, the current random access process is terminated, and a new random access process is initiated to the candidate cell indicated in the first indication information, based on the first indication information received this time.

In a possible manner, in case that the index of the candidate cell in the first indication information received this time is the same as the index of the candidate cell in the first indication information received last time, if the SSB Index is the same, the transmission power is ramped and PREAMBLE_POWER_RAMPING_COUNTER is increased by 1. Correspondingly, if the SSB Index is different, the transmission power of the preamble last time (that is, the transmission power of the preamble used most recently) is continuously used to transmit the current preamble, and at this time, there is no need to increase the value of PREAMBLE_POWER_RAMPING_COUNTER by 1.

It should be noted that each time the UE indicates the random access information to the underlying layer, the preamble may be transmitted based on the determined random access resource. For example, each time the UE indicates the random access information to the underlying layer, the preamble may be transmitted on the selected random access resource by using the determined transmission power of the preamble.

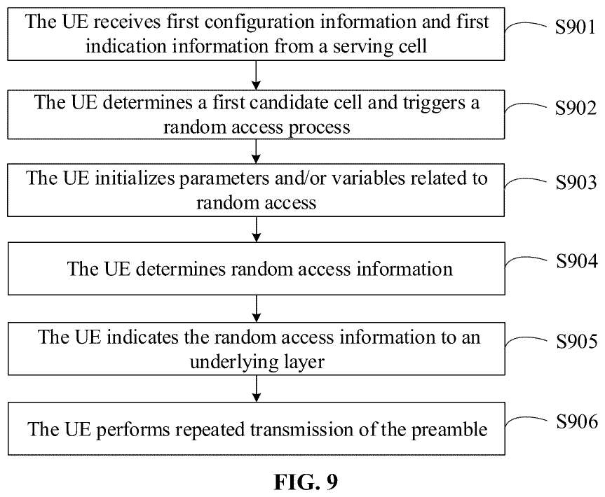

FIG. 9 is a third schematic diagram of a possible implementation flow of a method for UL synchronization provided in an embodiment of the disclosure. The implementation flow may include the following operations S901 to S906.

In operation S901, the UE receives first configuration information and first indication information from a serving cell.

In some embodiments, the serving cell may send the first configuration information to the UE, and correspondingly, the UE may receive the first configuration information from the serving cell. The first configuration information may include a cell configuration corresponding to at least one candidate cell for the LTM. It should be understood that the serving cell in the embodiment of the disclosure may be for example a PCell, a PSCell, or a SCell.

After receiving the first configuration information, the UE may perform L1 measurement on all or part of the at least one LTM candidate cell, and report a measurement result obtained by performing the L1 measurement to the serving cell.

In some embodiments, the serving cell may also send the first indication information to the UE, and correspondingly, the UE may receive the first indication information from the serving cell. Exemplarily, the first indication information may include, but is not limited to at least one of: an index (ID) of a candidate cell; an indication information of a random access resource; or parameter information related to the transmission power of the preamble. Introduction of the above information may refer to the operation S701 in the foregoing embodiment, which will not be elaborated here to avoid repetition.

In this embodiment, the first indication information may further include a maximum number of transmissions, and the maximum number of transmissions may indicate a maximum number of times (or an upper number limit) that the UE transmits the preamble in the random access process.

In operation S902, the UE determines a first candidate cell and triggers a random access process.

The UE may determine the first candidate cell according to the index of the first candidate cell in the first indication information, and trigger initiation of a random access process to the first candidate cell. As an example, initiation of the random access process to the first candidate cell by the UE may include the following operations S903 to S906.

In operation S903, the UE initializes parameters and/or variables related to random access.

For example, the parameters related to random access may include, but are not limited to: a preamble received target power (preamble ReceivedTargetPower) and/or a power ramping step (powerRampingStep). The variables related to random access may also be understood as variables that the UE needs to maintain in the random access process. For example, the variables related to random access may include, but are not limited to at least one of: a cell maximum transmission power (PCMAX), a Preamble Index (PREAMBLE_INDEX), a preamble received target power (PREAMBLE_RECEIVED_TARGET_POWER), a number of power ramping of the preamble (PREAMBLE_POWER_RAMPING_COUNTER), or a number of transmissions of the preamble (PREAMBLE_TRANSMISSION_COUNTER). The number of transmissions of the preamble indicates a number of times that the UE transmits the preamble in the random access process.

In a possible manner, all or part of power-related parameters such as preamble ReceivedTargetPower, powerRampingStep or the like may be for example determined by the first indication information; in another possible manner, all or part of the above power-related parameters may also be determined by a first RRC configuration, and the first RRC configuration is a configuration required to initiate random access to the first candidate cell.

In an example, the first RRC configuration may be contained in a cell configuration corresponding to the first candidate cell. For example, the first RRC configuration is a RACH configuration on a First Active BWP of the first candidate cell. In another example, the first RRC configuration may also be contained in a cell configuration corresponding to the current serving cell of the UE. In yet another example, the first RRC configuration may also be determined based on the first indication information. For example, the first RRC configuration may be a RACH configuration on a BWP corresponding to a BWP ID in the first indication information, such that the UE may determine a corresponding BWP based on the BWP ID in the first indication information, and then determine the RACH configuration on the BWP as the first RRC configuration.

In operation S904, the UE determines random access information.

The random access information may include: random access resource information and/or transmission power of the preamble.

Exemplarily, the UE may determine the random access resource information by selecting a random access resource. The random access resource selected by the UE may include: NUL/SUL, a BWP, a RACH Preamble Index, an SSB Index, and a PRACH Mask Index. The random access resource selected by the UE may be a random access resource indicated in the first indication information, or the random access resource selected by the UE is determined based on indication information of the random access resource in the first indication information.

Exemplarily, the UE may also determine the transmission power of the preamble.

In a first implementation, the transmission power of the preamble may be determined based on the first RRC configuration and the number of power ramping of the preamble (PREAMBLE_POWER_RAMPING_COUNTER), and a calculation formula thereof is shown in formula (8) in the foregoing embodiment.

In a second implementation, the UE may use the same transmission power of the preamble each time it transmits (retransmits) the PRACH, that is, the UE may use the same transmission power of the preamble each time it transmits (retransmits) the preamble. Exemplarily, the transmission power of the preamble used by the UE may be determined by the first RRC configuration, or the transmission power of the preamble used by the UE may be contained in the first indication information, or may be indicated by the first indication information.

In operation S905, the UE indicates the random access information to an underlying layer.

In this operation, the UE may indicate (deliver) the random access information (the random access resource information and/or the transmission power of the preamble) determined in the operation S904 to the underlying layer.

After indicating the random access information to the underlying layer, behaviors of the UE may include the following operation S906.

In operation S906, the UE performs repeated transmission of the preamble.

Exemplarily, the UE may perform repeated transmission of the preamble with a first time interval as a retransmission interval.

In a first possible manner, the first time interval may be controlled by a timer. For example, the UE may start the second timer, and may retransmit the preamble after the second timer times out. After each retransmission, the UE may increase PREAMBLE_TRANSMISSION_COUNTER by 1. If the value of the transmission power of the preamble used when the preamble is transmitted (retransmitted) this time is greater than the transmission power of the preamble used when the preamble is transmitted (retransmitted) in the previous time, PREAMBLE_POWER_RAMPING_COUNTER may be increased by 1. When PREAMBLE_TRANSMISSION_COUNTER reaches a first pre-configured number of times or reaches the first pre-configured number of times+1, it may be considered that the random access process is completed. The first pre-configured number of times may be for example the maximum number of transmissions in the first indication information.

In a second possible manner, the first time interval may be a determined time interval (for example, referred to as a first interval). In this case, the UE may retransmit the preamble after the first interval. After each retransmission, the UE may increase PREAMBLE_TRANSMISSION_COUNTER by 1. If the value of the transmission power of the preamble used when the preamble is transmitted (retransmitted) this time is greater than the transmission power of the preamble used when the preamble is transmitted (retransmitted) in the previous time, PREAMBLE_POWER_RAMPING_COUNTER may be increased by 1. When PREAMBLE_TRANSMISSION_COUNTER reaches a first pre-configured number of times or reaches the first pre-configured number of times+1, it may be considered that the random access process is completed. The first pre-configured number of times may be for example the maximum number of transmissions in the first indication information.

In an example, the first interval may be a time interval pre-configured by the network. After the first interval, the UE re-selects random access and/or determines the transmission power of the preamble based on the operation S904. In another example, the first interval may also be an interval between two or more adjacent PRACH occasions. The PRACH occasion may be for example determined by an SSB Index, a PRACH Mask Index and the first RRC configuration in the first indication information.

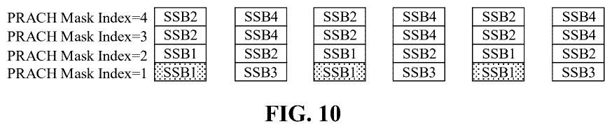

Taking FIG. 10 as an example, assuming that a number of retransmissions configured by the network is 3, the UE may perform transmission of the preamble on 3 continuous PRACH occasions by 3 times. For example, if each of the SSB Index and the PRACH Mask Index in the first indication information is equal to 1, the UE may perform three continuous transmissions on PRACH occasions corresponding to shaded portions in FIG. 10. The random access resource and/or the transmission power of the preamble used for the three continuous transmissions may be determined by the operation S904.

In a third possible manner, after the UE receives acknowledgment information (corresponding to the second information in the foregoing embodiment) from the serving cell, it may be considered that the random access process is completed. The acknowledgment information is a response of the serving cell of the UE to transmission of the preamble by the UE. As an implementation, after receiving the acknowledgment information, the UE may stop retransmission. The acknowledgment information may be for example carried by Downlink Control Information (DCI) or MAC CE.

As an implementation, if the UE receives the first indication information again during retransmission of the PRACH, and the index of the candidate cell in the first indication information received this time is different from the index of the first candidate cell, then the UE may stop the current random access process and initiate a new random access process based on the first indication information received this time. Alternatively, as another implementation, if the UE receives the first indication information again during retransmission of the PRACH, and the index of the candidate cell in the first indication information received this time is different from the index of the first candidate cell, then the UE may also continuously perform the current random access process. In some scenarios, if the UE continuously performs the current random access process, the UE may also feed back to the serving cell that there is an ongoing RACH procedure at present.

It should be noted that implementation flows illustrated in FIG. 8 and FIG. 9 may also support that power ramping is performed once after multiple repeated transmissions. That is, the UE may perform more than one transmissions of the preamble with the same transmission power of the preamble, and then increase the value of REAMBLE_POWER_RAMPING_COUNTER by 1.

It should also be noted that for implementation flows illustrated in FIG. 7 to FIG. 9, in some embodiments, if the UE receives the first indication information again in the process of initiating random access to the serving cell, the UE may ignore the first indication information. In some embodiments, if the event triggering random access to the serving cell is met in the process of the UE initiating random access to the first candidate cell, the UE may terminate the random access process initiated to the candidate cell and trigger initiation of the random access process to the current serving cell. That is, if the event triggering random access to the serving cell is met in the process of the UE initiating random access to the first candidate cell, the UE may terminate the current random access process and preferentially initiates a random access process to the serving cell.

The technical solutions of the embodiments of the disclosure clarify how the UE determines whether the RACH procedure (random access process) is completed and how to perform power ramping, in a random access process where there is no need to receive the RAR.

According to the methods of the embodiments of the disclosure, the solution for determining whether the random access process is completed may include the following manners 1 to 3.

Manner 1: after the UE delivers the random access information to the underlying layer, it is considered that the random access process is completed.

Manner 2: After the UE delivers the random access information to the underlying layer, a timer is started, and during operation of the timer, it is determined whether the preamble needs to be retransmitted, based on whether the first indication information is received. If the timer times out, it may be considered that the random access process is completed.

Manner 3: after the UE continuously performs multiple transmissions of the preamble based on configuration of the network side, it is considered that the random access process is completed. For example, when the number of transmissions of the preamble reaches the first pre-configured number of times or reaches the first pre-configured number of times+1, it may be considered that the random access process is completed.

According to the methods of the embodiments of the disclosure, the solution for determining the transmission power of the preamble may include the following manners 1 to 3.
Manner 1: the transmission power of the preamble is contained in the first indication information.
Manner 2: the transmission power of the preamble is determined based on the first indication information and the first RRC configuration. In this manner, the first indication information may include, but is not limited to at least one of: a first power ramping step, a power ramping counter, a power ramping offset, or a power ramping factor.
Manner 3: the transmission power of the preamble is determined based on the first RRC configuration and the number of power ramping of the preamble.

Based on the foregoing embodiments, the embodiments of the disclosure provide corresponding apparatuses for UL synchronization.

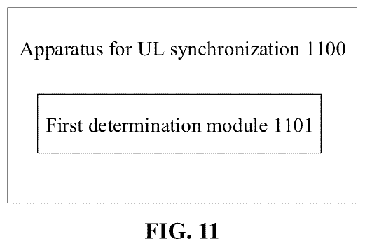

FIG. 11 is a first schematic diagram of structural composition of an apparatus for UL synchronization provided in an embodiment of the disclosure, the apparatus for UL synchronization is applied to a terminal device. As illustrated in FIG. 11, the apparatus for UL synchronization 1100 includes a first determination module 1101.

The first determination module 1101 is configured to in case that a first condition is met, determine that a first random access process is completed, the first random access process is used to establish UL synchronization between the apparatus 1100 and a first candidate cell, and the first condition is related to indicating that an underlying layer of the apparatus 1100 transmits a preamble by using a first information.

In some embodiments, the first condition includes: indicating that the underlying layer of the apparatus 1100 transmits the preamble by using the first information.

In some embodiments, the first condition includes: a first timer times out. The first timer is started after it is indicated that the underlying layer of the apparatus 1100 transmits the preamble by using the first information.

In some embodiments, the first timer is stopped in case that a first indication information is received. The first indication information is used to trigger a random access process.

In some embodiments, the apparatus 1100 further includes a second determination module. The second determination module is configured to in case that the first indication information is received during operation of the first timer, determine, based on the first indication information, whether the first random access process is continuously performed.

In some embodiments, if the first indication information meets a second condition, the apparatus 1100 continuously performs the first random access process; or if the first indication information does not meet the second condition, the apparatus 1100 initiates a second random access process based on the first indication information.

In some embodiments, the second condition includes: an index of a candidate cell contained in the first indication information is the same as an index of the first candidate cell; and/or a random access resource indicated by the first indication information is the same as a random access resource of the first random access process.

In some embodiments, the first condition includes: a number of transmissions of the preamble reaches a first number, or a second information is received before the number of transmissions of the preamble reaches the first number. The preamble is transmitted after it is indicated that the underlying layer of the apparatus 1100 transmits a random access preamble by using the first information, and the second information is a response of a network device to transmission of the preamble.

In some embodiments, the apparatus 1100 further includes a retransmission module. The retransmission module is configured to perform repeated transmission of the preamble.

In some embodiments, a transmission interval of the repeated transmission is: a timing duration of a second timer; or an occurrence period of a random access resource.

In some embodiments, the apparatus 1100 further includes a stopping module. The stopping module is configured to in case that the second information is received before the number of transmissions of the preamble reaches the first number, stop transmission of the preamble.

In some embodiments, the first determination module 1101 is specifically configured to in case that there is no need to receive a RAR and the first condition is met, determine that the first random access process is completed.

In some embodiments, the apparatus 1100 includes a first receiving module. The first receiving module is configured to receive third information from a network device. The third information is used to indicate whether the apparatus 1100 needs to receive the RAR.

In some embodiments, the apparatus 1100 further includes a first processing module. The first processing module is configured to in case that a first indication information is received in the first random access process, ignore the first indication information. The first indication information is used to trigger a random access process.

In some embodiments, the apparatus 1100 further includes an initiation module. The initiation module is configured to in case that an event triggering random access to a serving cell of the apparatus 1100 is met in the first random access process, terminate the first random access process, and initiate a third random access process to the serving cell of the apparatus 1100.

In some embodiments, the apparatus 1100 further includes a second processing module. The second processing module is configured to in case that a first indication information is received in the third random access process, ignore the first indication information. The first indication information is used to trigger a random access process.

In some embodiments, the first information includes: transmission power of the preamble, and/or random access resource information.

In some embodiments, the transmission power of the preamble is contained in fourth information, and the fourth information is related to the transmission power of the preamble; or the transmission power of the preamble is determined based on the fourth information and fifth information, and the fifth information is used to configure or initialize parameters and/or variables related to the first random access process; or the transmission power of the preamble is determined based on the fifth information and a number of power ramping of the preamble.

In some embodiments, a ramping rule of the transmission power of the preamble includes: ramping the transmission power of the preamble after performing at least one transmission of the preamble by using a same transmission power of the preamble; and/or based on whether SSBs contained in continuously received first indication information are the same, determining whether to ramp the transmission power of the preamble. The first indication information is used to trigger a random access process.

In some embodiments, the apparatus 1100 further includes a ramping module. The ramping module is configured to in case that it is determined to ramp the transmission power of the preamble, increase the number of power ramping of the preamble by 1.

In some embodiments, if the transmission power of the preamble is determined based on the fourth information and the fifth information, the fourth information includes at least one of: a first power ramping step; a power ramping counter; a power ramping offset; or a power ramping factor.

In some embodiments, the fourth information is contained in a first indication information, and the first indication information is used to trigger a random access process.

In some embodiments, the fifth information includes: a preamble received target power, and/or a second power ramping step.

In some embodiments, the fifth information is contained in a cell configuration corresponding to the first candidate cell; or the fifth information is contained in a cell configuration corresponding to a serving cell of the apparatus 1100; or the fifth information is determined based on a first indication information, and the first indication information is used to trigger a random access process.

In some embodiments, the cell configuration corresponding to the first candidate cell is contained in a cell configuration corresponding to at least one candidate cell from a network device.

In some embodiments, the fifth information further includes sixth information. In a process of configuring or initializing the parameters and/or variables related to the first random access process, the apparatus 1100 preferentially configures or initializes, based on the sixth information, the parameters and/or variables related to the first random access process.

In some embodiments, the fifth information is used for at least one of the following random access processes: a random access process triggered by layer 1 or layer 2 signaling; a random access process triggered by layer 3 signaling; or a random access process triggered by layer 1 or layer 2 signaling before receiving a cell handover command from the network device.

In some embodiments, the random access resource information is determined based on seventh information, and the seventh information is used to indicate a random access resource of the first random access process.

In some embodiments, the seventh information is contained in a first indication information, and the first indication information is used to trigger a random access process.

In some embodiments, the first candidate cell is determined based on an index of a candidate cell contained in a first indication information, and the first indication information is used to trigger a random access process.

In some embodiments, the apparatus 1100 further includes a monitoring module. The monitoring module is configured to: in case that the third information indicates that the RAR needs to be received, after indicating that the underlying layer of the apparatus 1100 transmits the preamble by using the first information, monitor the RAR on a serving cell of the apparatus 1100, and schedule a PDCCH of the RAR to be scrambled by a C-RNTI and/or a RA-RNTI; or monitor the RAR in the first candidate cell, and schedule the PDCCH of the RAR to be scrambled by the RA-RNTI.

In some embodiments, the apparatus 1100 further includes a third processing module. The third processing module is configured to: after having monitored the RAR, ignore a UL grant and/or a TC-RNTI carried in the RAR.

In some embodiments, the first random access process is a random access process triggered by layer 1 or layer 2 signaling.

In some embodiments, the apparatus 1100 further includes a second receiving module. The second receiving module is configured to before receiving a cell handover command from a network device, receive eighth information from the network device. The eighth information is used to determine a TA value between the apparatus 1100 and the first candidate cell.

In some embodiments, the eighth information includes: a DL timing difference between the first candidate cell and a serving cell of the apparatus 1100.

In some embodiments, the apparatus 1100 further includes a sending module. The sending module is configured to send ninth information to the network device. The ninth information includes at least one of: an ID of the first candidate cell; the TA value between the apparatus 1100 and the first candidate cell; or an adjustment amount based on a TA value used by a serving cell of the apparatus 1100.

In some embodiments, the apparatus 1100 further includes a third receiving module. The third receiving module is configured to: before sending the ninth information to the network device, receive tenth information from the network device. The tenth information is used to indicate the apparatus 1100 to determine the TA value between the apparatus 1100 and the first candidate cell, and/or send the ninth information to the network device.

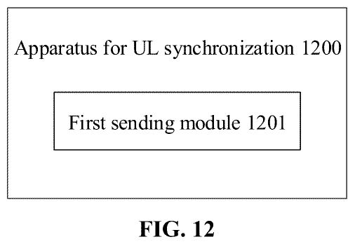

FIG. 12 is a second schematic diagram of structural composition of an apparatus for UL synchronization provided in an embodiment of the disclosure, the apparatus for UL synchronization is applied to a network device. As illustrated in FIG. 12, the apparatus for UL synchronization 1200 includes a first sending module 1201.

The first sending module 1201 is configured to send a first indication information to a terminal device, the first indication information is used to trigger a random access process, the first indication information is used by the terminal device to determine a first information, a first condition is related to indicating that an underlying layer of the terminal device transmits a preamble by using the first information, the first condition is used to determine that a first random access process is completed, and the first random access process is used to establish UL synchronization between the terminal device and a first candidate cell.

In some embodiments, the first condition includes: indicating that the underlying layer of the terminal device transmits the preamble by using the first information.

In some embodiments, the first condition includes: a first timer times out. The first timer is started after it is indicated the underlying layer of the terminal device transmits the preamble by using the first information.

In some embodiments, the first timer is stopped in case that the first indication information is received by the terminal device.

In some embodiments, the first condition includes: a number of transmissions of the preamble reaches a first number, or a second information is received by the terminal device before the number of transmissions of the preamble reaches the first number. The preamble is transmitted after it is indicated that the underlying layer of the terminal device transmits the preamble by using the first information, and the second information is a response of the apparatus 1200 to transmission of the preamble.

In some embodiments, the first condition is used to determine that the first random access process is completed, in case that the terminal device does not need to receive a RAR.

In some embodiments, the apparatus 1200 further includes a second sending module. The second sending module is configured to send third information to the terminal device. The third information is used to indicate whether the terminal device needs to receive the RAR.

In some embodiments, the first information includes: random access resource information, and/or transmission power of the preamble.

In some embodiments, the transmission power of the preamble is contained in fourth information, and the fourth information is related to the transmission power of the preamble; or the transmission power of the preamble is determined based on the fourth information and fifth information, and the fifth information is used to configure or initialize parameters and/or variables related to the first random access process; or the transmission power of the preamble is determined based on the fifth information and a number of power ramping of the preamble.

In some embodiments, if the transmission power of the preamble is determined based on the fourth information and the fifth information, the fourth information includes at least one of: a first power ramping step; a power ramping counter; a power ramping offset; or a power ramping factor.

In some embodiments, the fourth information is contained in the first indication information.

In some embodiments, the fifth information includes: a preamble received target power, and/or a second power ramping step.

In some embodiments, the fifth information is contained in a cell configuration corresponding to the first candidate cell; or the fifth information is contained in a cell configuration corresponding to a serving cell of the terminal device; or the fifth information is determined based on the first indication information.

In some embodiments, the cell configuration corresponding to the first candidate cell is contained in a cell configuration corresponding to at least one candidate cell sent to the terminal device.

In some embodiments, the fifth information further includes sixth information. In a process of configuring or initializing the parameters and/or variables related to the first random access process, the terminal device preferentially configures or initializes, based on the sixth information, the parameters and/or variables related to the first random access process.

In some embodiments, the fifth information is used for at least one of the following random access processes: a random access process triggered by layer 1 or layer 2 signaling; a random access process triggered by layer 3 signaling; or a random access process triggered by layer 1 or layer 2 signaling before sending a cell handover command to the terminal device.

In some embodiments, the random access resource information is determined based on seventh information, and the seventh information is used to indicate a random access resource of the first random access process.

In some embodiments, the seventh information is contained in the first indication information.

In some embodiments, the first candidate cell is determined by the terminal device based on an index of a candidate cell contained in the first indication information.

In some embodiments, the apparatus 1200 further includes a third sending module. The third sending module is configured to before sending a cell handover command to the terminal device, send eighth information to the terminal device. The eighth information is used to determine a TA value between the terminal device and the first candidate cell.

In some embodiments, the eighth information includes: a DL timing difference between the first candidate cell and a serving cell of the terminal device.

In some embodiments, the apparatus 1200 further includes a receiving module. The receiving module is configured to receive ninth information from the terminal device. The ninth information includes at least one of: an ID of the first candidate cell; the TA value between the terminal device and the first candidate cell; or an adjustment amount based on a TA value used by a serving cell of the terminal device.

In some embodiments, the apparatus 1200 further includes a fourth sending module. The fourth sending module is configured to before receiving the ninth information from the terminal device: send tenth information to the terminal device. The tenth information is used to indicate that the terminal device determines the TA value between the terminal device and the first candidate cell, and/or that the terminal device sends the ninth information to the apparatus 1200.

It should be understood by those skilled in the art that relevant descriptions of the above apparatuses for UL synchronization in the embodiments of the disclosure may be understood by referring to relevant descriptions of the methods for UL synchronization in the embodiments of the disclosure.

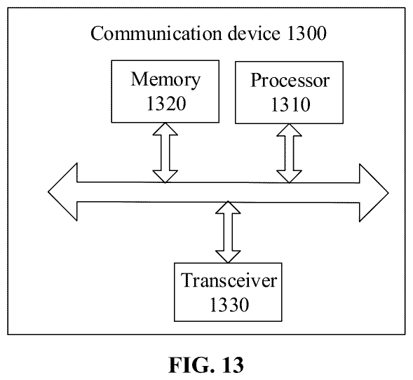

FIG. 13 is a schematic structural diagram of a communication device 1300 provided in an embodiment of the disclosure. The communication device may be a terminal device or a network device. The communication device 1300 illustrated in FIG. 13 includes a processor 1310, and the processor 1310 may call and run a computer program from a memory, to implement the methods in the embodiments of the disclosure.

Optionally, as illustrated in FIG. 13, the communication device 1300 may further include a memory 1320. The processor 1310 may call and run the computer program from the memory 1320, to implement the methods in the embodiments of the disclosure.

The memory 1320 may be an independent device independent of the processor 1310, or may be integrated into the processor 1310.

Optionally, as illustrated in FIG. 13, the communication device 1300 may further include a transceiver 1330, and the processor 1310 may control the transceiver 1330 to communicate with other devices. Specifically, the processor 1310 may control the transceiver 1330 to send information or data to other devices, or to receive information or data sent by other devices.

The transceiver 1330 may include a transmitter and a receiver. The transceiver 1330 may further include antenna, and there may be one or more antennas.

Optionally, the communication device 1300 may specifically be the network device in the embodiments of the disclosure, and the communication device 1300 may implement corresponding flows implemented by the network device in each method in the embodiments of the disclosure, which will not be elaborated here for the sake of brevity.

Optionally, the communication device 1300 may specifically be the terminal (mobile terminal/terminal device) in the embodiments of the disclosure, and the communication device 1300 may implement corresponding flows implemented by the terminal in each method in the embodiments of the disclosure, which will not be elaborated here for the sake of brevity.

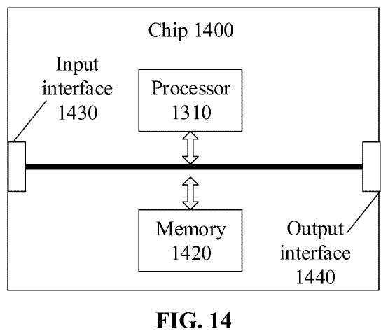

FIG. 14 is a schematic structural diagram of a chip according to an embodiment of the disclosure. The chip 1400 illustrated in FIG. 14 includes a processor 1410, and the processor 1410 may call and run a computer program from a memory, to implement the methods in the embodiments of the disclosure.

Optionally, as illustrated in FIG. 14, the chip 1400 may further include a memory 1420. The processor 1410 may call and run the computer program from the memory 1420, to implement the methods in the embodiments of the disclosure.

The memory 1420 may be an independent device independent of the processor 1410, or may be integrated into the processor 1410.

Optionally, the chip 1400 may further include an input interface 1430. The processor 1410 may control the input interface 1430 to communicate with other devices or chips, and specifically, the processor 1410 may control the input interface 1430 to acquire information or data sent by other devices or chips.

Optionally, the chip 1400 may further include an output interface 1440. The processor 1410 may control the output interface 1440 to communicate with other devices or chips, and specifically, the processor 1410 may control the output interface 1440 to output information or data to other devices or chips.

Optionally, the chip may be applied to the network device in the embodiments of the disclosure, and the chip may implement corresponding flows implemented by the network device in each method in the embodiments of the disclosure, which will not be elaborated here for the sake of brevity.

Optionally, the chip may be applied to the terminal (mobile terminal/terminal device) in the embodiments of the disclosure, and the chip may implement corresponding flows implemented by the terminal in each method in the embodiments of the disclosure, which will not be elaborated here for the sake of brevity.

It should be understood that the chip mentioned in the embodiment of the disclosure may also be referred to as a system-level chip, a system chip, a chip system or a system on chip, etc.

An embodiment of the disclosure further provides a computer storage medium, the computer storage medium has stored thereon one or more programs. The one or more programs may be executed by one or more processors, to implement the methods in the embodiments of the disclosure.

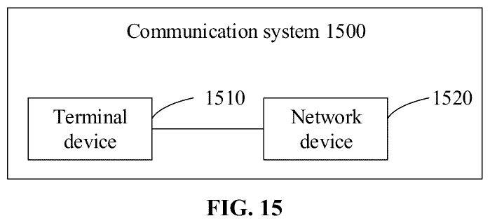

FIG. 15 is a schematic block diagram of a communication system 1500 provided in an embodiment of the disclosure. As illustrated in FIG. 15, the communication system 1500 includes a terminal device 1510 and a network device 1520.

The terminal device 1510 may be configured to implement corresponding functions implemented by the terminal device in the above methods, and the network device 1520 may be configured to implement corresponding functions implemented by the network device in the above methods, which will not be elaborated here for the sake of brevity.

It should be understood that the processor in the embodiment of the disclosure may be an integrated circuit chip with a signal processing capability. During implementation, each step in the above method embodiments may be completed by an integrated logical circuit in a form of hardware in the processor or an instruction in a form of software. The above processor may be a general purpose processor, a Digital Signal Processor (DSP), an Application Specific Integrated Circuit (ASIC), a Field Programmable Gate Array (FPGA) or other programmable logical devices, a discrete gate or transistor logical device, and a discrete hardware component. Each method, step and logical block diagram disclosed in the embodiments of the disclosure may be implemented or executed. The general purpose processor may be a microprocessor, or the processor may be any conventional processor, etc. Steps in the methods disclosed in combination with the embodiments of the disclosure may be directly embodied to be executed and completed by a hardware decoding processor, or executed and completed by a combination of hardware in the decoding processor and a software module. The software module may be located in a mature storage medium in this field such as a Random Access Memory (RAM), a flash memory, a Read-Only Memory (ROM), a Programmable ROM (PROM) or Electrically Erasable PROM (EEPROM), a register, etc. The storage medium is located in a memory, and the processor reads information in the memory, and completes the steps in the above methods in combination with the hardware thereof.

It may be understood that the memory in the embodiment of the disclosure may be a volatile memory or a non-volatile memory, or may include both the volatile and non-volatile memories. The non-volatile memory may be a ROM, a PROM, an Erasable PROM (EPROM), an EEPROM or a flash memory. The volatile memory may be a RAM, which is used as an external high-speed cache. Through an exemplary rather than limiting description, many forms of RAMs are available, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It should be noted that the memory in the system and method described in the disclosure is intended to include, but is not limited to these memories and any other suitable types of memories.

It should be understood that the above memory is an exemplary rather than limiting description. For example, the memory in the embodiment of the disclosure may also be an SRAM, a DRAM, an SDRAM, a DDR SDRAM, an ESDRAM, an SLDRAM, a DR RAM, etc. That is, the memory in the embodiment of the disclosure is intended to include, but is not limited to these memories and any other suitable types of memories.

An embodiment of the disclosure further provides a computer-readable storage medium, the computer-readable storage medium is configured to store a computer program.

Optionally, the computer-readable storage medium may be applied to the network device in the embodiments of the disclosure, and the computer program enables a computer to execute corresponding flows implemented by the network device in each method in the embodiments of the disclosure, which will not be elaborated here for the sake of brevity.

Optionally, the computer-readable storage medium may be applied to the terminal (mobile terminal/terminal device) in the embodiments of the disclosure, and the computer program enables a computer to execute corresponding flows implemented by the terminal in each method in the embodiments of the disclosure, which will not be elaborated here for the sake of brevity.

An embodiment of the disclosure further provides a computer program product, the computer program product includes computer program instructions.

Optionally, the computer program product may be applied to the network device in the embodiments of the disclosure, and the computer program instructions enable a computer to execute corresponding flows implemented by the network device in each method in the embodiments of the disclosure, which will not be elaborated here for the sake of brevity.

Optionally, the computer program product may be applied to the terminal (mobile terminal/terminal device) in the embodiments of the disclosure, and the computer program instructions enable a computer to execute corresponding flows implemented by the terminal in each method in the embodiments of the disclosure, which will not be elaborated here for the sake of brevity.

An embodiment of the disclosure further provides a computer program.

Optionally, the computer program may be applied to the network device in the embodiments of the disclosure, and when the computer program is executed in a computer, the computer program enables the computer to execute corresponding flows implemented by the network device in each method in the embodiments of the disclosure, which will not be elaborated here for the sake of brevity.

Optionally, the computer program may be applied to the terminal (mobile terminal/terminal device) in the embodiments of the disclosure, and when the computer program is executed in a computer, the computer program enables the computer to execute corresponding flows implemented by the terminal in each method in the embodiments of the disclosure, which will not be elaborated here for the sake of brevity.

It may be appreciated by those of ordinary skill in the art that the units and algorithm steps of each example described in combination with the embodiments disclosed in the disclosure may be implemented by electronic hardware or a combination of computer software and the electronic hardware. Whether these functions are executed in a hardware or software manner, depends on specific applications and design constraints of the technical solutions. Professionals may implement the described functions by using different methods for each specific application, however, such implementation should not be considered as going beyond the scope of the disclosure.

It may be clearly understood by those skilled in the art that specific operation processes of the above system, apparatus and unit may refer to corresponding processes in the foregoing method embodiments and will not be elaborated here, for convenient and brief descriptions.

In several embodiments provided in the disclosure, it should be understood that the disclosed system, apparatus and method may be implemented in other manners. For example, the above apparatus embodiments are schematic only. For example, division of the units is only logic function division, and there may be other division manners in an actual implementation. For example, multiple units or components may be combined or integrated into another system, or some features may be ignored or may not be executed. In addition, coupling or direct coupling or communication connection between displayed or discussed components may be indirect coupling or communication connection of the apparatus or the units implemented through some interfaces, and may be electrical, mechanical or adopt other forms.

The units described as separate components may be or may not be physically separated, and components displayed as units may be or may not be physical units, that is, they may be located at the same place, or may be distributed to multiple network units. Part or all of the units may be selected to achieve the purpose of the solutions in the embodiments according to actual requirements.

Furthermore, each functional unit in each embodiment of the disclosure may be integrated into a processing unit, or each unit may physically exist independently, or two or more than two units may be integrated into a unit.

When the function is implemented in a form of software functional unit and is sold or used as an independent product, the function may be stored in a computer-readable storage medium. Based on such understanding, the technical solutions of the disclosure substantially or parts making contributions to the related art or part of the technical solutions may be embodied in a form of software product, and the computer software product is stored in a storage medium, and includes several instructions used to enable a computer device (which may be a personal computer, a server, a network device, etc.) to execute all or part of steps of the method described in each embodiment of the disclosure. The foregoing storage medium includes various media capable of storing program codes, such as a U disk, a mobile hard disk, a ROM, a RAM, a magnetic disk, or an optical disk, etc.

The above descriptions are only specific implementations of the disclosure, however, the scope of protection of the disclosure is not limited thereto. Variation or replacement easily conceived by any technician familiar with this technical field within the technical scope disclosed in the disclosure, should fall within the scope of protection of the disclosure. Therefore, the scope of protection of the disclosure shall be subject to the scope of protection of the claims.

1. A method for uplink (UL) synchronization, applied to a terminal device, comprising:
in case that a first condition is met, determining that a first random access process is completed, wherein the first random access process is used to establish UL synchronization between the terminal device and a first candidate cell, and the first condition is related to indicating that an underlying layer of the terminal device transmits a preamble by using a first information.

2. The method of claim 1, wherein the first condition comprises:
indicating that the underlying layer of the terminal device transmits the preamble by using the first information.

3. The method of claim 1, wherein in case that the first condition is met, determining that the first random access process is completed comprises:
in case that there is no need to receive a Random Access Response (RAR) and the first condition is met, determining that the first random access process is completed.

4. The method of claim 1, wherein the first information comprises:
transmission power of the preamble, and/or random access resource information;
wherein the transmission power of the preamble is contained in fourth information, and the fourth information is related to the transmission power of the preamble; or
the transmission power of the preamble is determined based on the fourth information and fifth information, and the fifth information is used to configure or initialize parameters and/or variables related to the first random access process; or
the transmission power of the preamble is determined based on the fifth information and a number of power ramping of the preamble;
wherein a ramping rule of the transmission power of the preamble comprises:
ramping the transmission power of the preamble after performing at least one transmission of the preamble by using a same transmission power of the preamble; and/or
based on whether Synchronization Signal Blocks (SSBs) contained in continuously received first indication information are same, determining whether to ramp the transmission power of the preamble, wherein the first indication information is used to trigger a random access process;
wherein the method further comprises:
in case that it is determined to ramp the transmission power of the preamble, increasing the number of power ramping of the preamble by 1.

5. The method of claim 4, wherein when the transmission power of the preamble is determined based on the fourth information and the fifth information, the fourth information comprises at least one of:
a first power ramping step;
a power ramping counter;
a power ramping offset; or
a power ramping factor;
wherein the fourth information is contained in a first indication information, and the first indication information is used to trigger a random access process.

6. The method of claim 4, wherein the fifth information comprises: a preamble received target power, and/or a second power ramping step;
wherein the fifth information is contained in a cell configuration corresponding to the first candidate cell; or
the fifth information is contained in a cell configuration corresponding to a serving cell of the terminal device; or
the fifth information is determined based on a first indication information, and the first indication information is used to trigger a random access process;
wherein the cell configuration corresponding to the first candidate cell is contained in a cell configuration corresponding to at least one candidate cell from a network device.

7. The method of claim 4, wherein the fifth information further comprises sixth information, and
wherein in a process of configuring or initializing the parameters and/or variables related to the first random access process, the terminal device preferentially configures or initializes, based on the sixth information, the parameters and/or variables related to the first random access process;
wherein the fifth information is used for at least one of the following random access processes:
a random access process triggered by layer 1 or layer 2 signaling;
a random access process triggered by layer 3 signaling; or
a random access process triggered by layer 1 or layer 2 signaling before receiving a cell handover command from the network device.

8. The method of claim 4, wherein the random access resource information is determined based on seventh information, and the seventh information indicates a random access resource of the first random access process;
wherein the seventh information is contained in a first indication information, and the first indication information is used to trigger a random access process.

9. The method of claim 1, wherein the first candidate cell is determined based on an index of a candidate cell contained in a first indication information, and the first indication information is used to trigger a random access process.

10. The method of claim 1, wherein the first random access process is a random access process triggered by layer 1 or layer 2 signaling;
wherein the method further comprises:
receiving eighth information from the network device before receiving a cell handover command from a network device, wherein the eighth information is used to determine a timing advance (TA) value between the terminal device and the first candidate cell;
wherein the method further comprises:
sending ninth information to the network device, wherein the ninth information comprises at least one of:
an identifier (ID) of the first candidate cell;
the TA value between the terminal device and the first candidate cell; or
an adjustment amount based on a TA value used by a serving cell of the terminal device.

11. A terminal device for uplink (UL) synchronization, comprising:
a memory, configured to store computer executable instructions; and
a processor, connected to the memory, and configured to execute the computer executable instructions to cause the terminal device to:
in case that a first condition is met, determine that a first random access process is completed, wherein the first random access process is used to establish UL synchronization between the apparatus and a first candidate cell, and the first condition is related to indicating that an underlying layer of the apparatus transmits a preamble by using a first information.

12. The terminal device of claim 11, wherein the first condition comprises:
indicating that the underlying layer of the terminal device transmits the preamble by using the first information.

13. The terminal device of claim 11, wherein the processor is specifically configured to cause the terminal device to:
in case that there is no need to receive a Random Access Response (RAR) and the first condition is met, determine that the first random access process is completed.

14. The terminal device of claim 11, wherein the first information comprises:
transmission power of the preamble, and/or random access resource information.

15. The terminal device of claim 14, wherein the transmission power of the preamble is contained in fourth information, and the fourth information is related to the transmission power of the preamble; or
the transmission power of the preamble is determined based on the fourth information and fifth information, and the fifth information is used to configure or initialize parameters and/or variables related to the first random access process; or
the transmission power of the preamble is determined based on the fifth information and a number of power ramping of the preamble.

16. A network device for uplink (UL) synchronization, comprising:
a memory, configured to store computer executable instructions; and
a processor, connected to the memory, and configured to execute the computer executable instructions to cause the network device to:
send a first indication information to a terminal device, wherein the first indication information is used to trigger a random access process, the first indication information is used by the terminal device to determine a first information, a first condition is related to indicating that an underlying layer of the terminal device transmits a preamble by using the first information, the first condition is used to determine that a first random access process is completed, and the first random access process is used to establish UL synchronization between the terminal device and a first candidate cell.

17. The network device of claim 16, wherein the first condition comprises:
indicating that the underlying layer of the terminal device transmits the preamble by using the first information.

18. The network device of claim 16, wherein the first condition is used to determine that the first random access process is completed, in case that the terminal device does not need to receive a Random Access Response (RAR).

19. The network device of claim 16, wherein the first information comprises:
random access resource information, and/or transmission power of the preamble.

20. The network device of claim 19, wherein the transmission power of the preamble is contained in fourth information, and the fourth information is related to the transmission power of the preamble; or
the transmission power of the preamble is determined based on the fourth information and fifth information, and the fifth information is used to configure or initialize parameters and/or variables related to the first random access process; or
the transmission power of the preamble is determined based on the fifth information and a number of power ramping of the preamble.
